(19) United States
(12) Patent Application Publication
(10) Pub. No.: US 2024/0363909 A1
(43) Pub. Date: Oct. 31, 2024

(54) ELECTRODE SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Yo KUSHIDA, Kanagawa (JP); Hideyuki SUZUKI, Kanagawa (JP)

(73) Assignee: FUJIFILM Corporation, Tokyo (JP)

(21) Appl. No.: 18/766,691

(22) Filed: Jul. 9, 2024

Related U.S. Application Data
(63) Continuation of application No. PCT/JP2023/010958, filed on Mar. 20, 2023.

(30) Foreign Application Priority Data
Mar. 25, 2022 (JP) 2022-050216

(51) Int. Cl. H01M 10/42; H01M 4/02; H01M 4/131; H01M 4/62; H01M 10/0562; H01M 10/0585; H01M 50/586; H01M 50/59

(52) U.S. Cl. CPC H01M 10/4235; H01M 4/131; H01M 4/622; H01M 10/0562; H01M 10/0585; H01M 50/586; H01M 50/59; H01M 2004/027; H01M 2004/028; H01M 2300/0068

(57) ABSTRACT

There is provided an electrode sheet for an all-solid state secondary battery, which has an electrode active material layer containing an inorganic solid electrolyte (B) and an active material (C) on at least one surface of a collector, where the electrode sheet for an all-solid state secondary battery has an insulating polymer anchored portion that contains 50% by mass or more of a polymer (A) having a solubility of 1 g/100 g or more in water at 25° C., at a part of an interface between the collector and the electrode active material layer. There is also provided an all-solid state secondary battery in which a positive electrode or a negative electrode is composed of the electrode sheet for an all-solid state secondary battery.

### CROSS-REFERENCE TO RELATED APPLICATIONS

This application is a Continuation of PCT International Application No. PCT/JP2023/010958 filed on Mar. 20, 2023, which claims priority under 35 U.S.C. § 119 (a) to Japanese Patent Application No. 2022-050216 filed in Japan on Mar. 25, 2022. Each of the above applications is hereby expressly incorporated by reference, in its entirety, into the present application.

### BACKGROUND OF THE INVENTION

### 1. Field of the Invention

The present invention relates to an electrode sheet for an all-solid state secondary battery and an all-solid state secondary battery.

### 2. Description of the Related Art

In an all-solid state secondary battery, all of a negative electrode, an electrolyte, and a positive electrode are solid, and thus it is possible to significantly improve safety and reliability which are considered as a problem of a battery in which an organic electrolytic solution is used. In addition, it is also said to be capable of extending the battery life. Further, the all-solid state secondary battery can be allowed to have a structure in which the electrodes and the electrolyte are directly disposed in series. As a result, it becomes possible to increase the energy density to be high as compared with a secondary battery in which an organic electrolytic solution is used, and thus the application to electric vehicles, large-sized storage batteries, and the like is anticipated.

In an all-solid state secondary battery, solid particles such as an inorganic solid electrolyte, an active material, and a conductive auxiliary agent are used as a substance that forms electrode layers (a negative electrode active material layer and a positive electrode active material layer) that are laminated on a collector. This inorganic solid electrolyte, particularly an oxide-based inorganic solid electrolyte or a sulfide-based inorganic solid electrolyte is expected as an electrolyte material having a high ion conductivity comparable to that of the organic electrolytic solution.

However, since the electrode layer is composed of the above-described solid particles, the interfacial contact state between the solid particles in the electrode layer and the interfacial contact state between the electrode layer (solid particles constituting the electrode layer) and the collector are restricted even in a case of a material that exhibits high ion conductivity, and thus the interface resistance is likely to increase. As a result, not only an increase in battery resistance (a decrease in ion conductivity) of an all-solid state secondary battery but also a decrease in cycle characteristics thereof are caused. In addition, since the adhesive force between the solid particles and between the electrode layer and the collector is not sufficient, the cycle characteristics of the all-solid state secondary battery are further deteriorated, and the electrode layer is peeled off from the collector in a case where an application is made to industrial manufacturing, for example, a roll-to-roll method having high productivity, which is one factor that causes the increase in interface resistance and the deterioration of cycle characteristics. As described above, in the all-solid state secondary battery, it is necessary to enhance not only the adhesiveness between the solid particles but also the interlayer adhesiveness in a laminate (also referred to as an electrode sheet for an all-solid state secondary battery) of the electrode layer and the collector.

Therefore, studies have been carried out to provide an intimate attachment layer between the collector and the electrode layer to improve the adhesiveness therebetween. For example, JP2014-093156A discloses “an electrode for an all-solid state type lithium ion battery, which is a sheet-shaped electrode that is used in a positive electrode layer or a negative electrode layer of an all-solid state lithium ion battery, where the sheet-shaped electrode is such that an electrode active material layer containing a particulate electrode active material, a conductive resin layer, and a collector layer are laminated in this order”. In addition, WO2019/230592A discloses an electrode that uses “a collector with an easy adhesion layer, having an easy adhesion layer that is provided on at least one surface of a collector, where the easy adhesion layer contains a polymer having a solubility of 1 g/100 g or higher in toluene at 25° C.”, where the electrode is “an electrode having an electrode active material layer containing a solid electrolyte, on a surface on which an easy adhesion layer is provided”. In a case of being once dissolved at the time of forming an active material layer, This easy adhesion layer functions to firmly adhere the collector to the electrode active material layer while ensuring electron conductivity.

### SUMMARY OF THE INVENTION

The electrode for an all-solid state type lithium ion battery disclosed in JP2014-093156A is such one that reinforces the interlayer adhesive force between the collector and the active material layer while ensuring electron conductivity by the conductive fine particles contained in the conductive resin layer. However, in this electrode for an all-solid state lithium ion battery, the ensuring of electron conductivity and the reinforcement of the interlayer adhesive force are in a relationship of being contrary to each other depending on the amount of content of the conductive particles, and thus it is difficult to achieve both of these.

However, in recent years, research and development for the performance improvement, the practical application, and the like of electric vehicles have progressed rapidly, and in association with this, it has been required that in a laminate of an electrode layer and a collector, which is used as an electrode of an all-solid state secondary battery, both the ensuring of electron conductivity (the suppression of an increase in resistance) and the reinforcement of interlayer adhesive force are achieved at a higher level.

An object of the present invention is to provide an electrode sheet for an all-solid state secondary battery, in which an electrode active material layer and a collector are firmly bound to each other while maintaining electron conductivity. In addition, another object of the present invention is to provide an all-solid state secondary battery having high ion conductivity and excellent cycle characteristics, in which this electrode sheet is used.

As a result of various studies, the inventors of the present invention found that instead of providing a conductive polymer layer on the entire surface of a collector (covering the entire surface of the collector with a conductive polymer layer), in a case where a polymer is anchored on a part of the surface of the collector to allow a surface (a surface planned to be subjected to lamination) on which an electrode active material layer is to be provided, to be in a state where an insulating polymer anchored portion to which the polymer has been anchored and an electron conductive portion in which the surface of the collector is exposed are mixedly present, it is possible to reinforce the interlayer adhesive force, while maintaining the electron conductivity between the electrode active material layer and the collector which are to be laminated on this surface planned to be subjected to lamination. In addition, it was found that in a case where an electrode sheet, in which such a collector and an electrode active material layer are laminated with the polymer anchored portion and the electron conductive portion being interposed therebetween, is incorporated as an electrode of an all-solid state secondary battery, it is possible to realize an all-solid state secondary battery that exhibits high ion conductivity and excellent cycle characteristics. The present invention has been completed through further studies based on these findings.

That is, the above problems have been solved by the following means.

<1> An electrode sheet for an all-solid state secondary battery, comprising:
an electrode active material layer on at least one surface of a collector,
in which the electrode active material layer has an inorganic solid electrolyte (B) having an ion conductivity of a metal belonging to Group 1 or Group 2 in the periodic table, and an active material (C), and
the electrode sheet for an all-solid state secondary battery has an insulating polymer anchored portion that contains 50% by mass or more of a polymer (A) having a solubility of 1 g/100 g or more in water at 25° C., at a part of an interface between the collector and the electrode active material layer.

<2> The electrode sheet for an all-solid state secondary battery according to <1>, in which the polymer anchored portion does not contain conductive particles.

<3> The electrode sheet for an all-solid state secondary battery according to <1> or <2>, in which the polymer (A) has the following acidic functional group or a salt thereof,
(Acidic functional group)
a carboxy group, a phosphate group, a phosphonate group, a phosphinate group, and a sulfonate group.

<4> The electrode sheet for an all-solid state secondary battery according to any one of <1> to <3>, in which the polymer (A) has a salt of a basic functional group.

<5> The electrode sheet for an all-solid state secondary battery according to any one of <1> to <4>, in which the inorganic solid electrolyte is a sulfide-based inorganic solid electrolyte.

<6> The electrode sheet for an all-solid state secondary battery according to any one of <1> to <5>, in which the polymer (A) includes at least one of a (meth)acrylic polymer or a vinyl polymer.

<7> The electrode sheet for an all-solid state secondary battery according to any one of <1> to <6>, in which the electrode active material layer contains a binder (D).

<8> The electrode sheet for an all-solid state secondary battery according to <7>, in which the binder (D) includes at least one of a (meth)acrylic polymer or a vinyl polymer.

<9> An all-solid state secondary battery comprising:
a positive electrode;
a negative electrode; and
a solid electrolyte layer between the positive electrode and the negative electrode,
in which at least one of the positive electrode or the negative electrode is composed of the electrode sheet for an all-solid state secondary battery according to any one of <1> to <8>.

In the electrode sheet for an all-solid state secondary battery according to the aspect of the present invention, the collector and the electrode active material layer are laminated with each other with a strong adhesive force while maintaining high electron conductivity. Therefore, in a case of being incorporated as an electrode of an all-solid state secondary battery, the electrode sheet for an all-solid state secondary battery according to the aspect of the present invention makes it possible to realize an all-solid state secondary battery that exhibits excellent cycle characteristics while maintaining high ion conductivity. In addition, since the all-solid state secondary battery according to the aspect of the present invention has the electrode sheet for an all-solid state secondary battery according to the aspect of the present invention as an electrode, it exhibits excellent cycle characteristics while maintaining high ion conductivity.

The above-described and other characteristics and advantages of the present invention will be further clarified by the following description with appropriate reference to the accompanying drawing.

### BRIEF DESCRIPTION OF THE DRAWINGS

FIG. 1 is a longitudinal cross-sectional view schematically illustrating an electrode sheet for an all-solid state secondary battery according to a preferred embodiment of the present invention.

FIG. 2 is a longitudinal cross-sectional view schematically illustrating an all-solid state secondary battery according to a preferred embodiment of the present invention.

FIG. 3A to FIG. 3D are top views of an interface between a collector and an electrode active material layer, which schematically illustrates an example of an arrangement state of a polymer anchored portion and an electron conductive portion in the electrode sheet for an all-solid state secondary battery according to the preferred embodiment of the present invention. FIG. 3A is a view showing an example of a sea-island arrangement state in which dot-shaped polymer anchored portions 23 are irregularly disposed in an electron conductive portion 22a, FIG. 3B is a view showing an example of a sea-island arrangement state in which the dot-shaped electron conductive portions 22a are irregularly disposed in the polymer anchored portion 22, FIG. 3C is a view showing an example of a sea-island arrangement state in which the a plurality of the polymer anchored portions 23 which are linear are disposed in parallel in the electron conductive portion 22a, and FIG. 3D is a view showing an example of a sea-island arrangement state in which the dot-shaped polymer anchored portions 23 are disposed in a mountain-valley repeating shape in the electron conductive portion 22a.

### DESCRIPTION OF THE PREFERRED EMBODIMENTS

In the present invention, in a case where a numerical value range is shown to describe a content, physical properties, or the like of a component, any upper limit value and any lower limit value can be appropriately combined to obtain a specific numerical value range in a case where an upper limit value and a lower limit value of the numerical value range are described separately. On the other hand, in a case where a numerical value range is described using “to”, a numerical value range indicated using “to” means a range including numerical values before and after the “to” as the lower limit value and the upper limit value. In addition, in a case where a plurality of numerical value ranges are set to make a description using “to”, the upper limit value and the lower limit value, which form each of the numerical value ranges, are not limited to a combination of a specific upper limit value and a specific lower limit value described before and after “to” as a specific numerical value range and can be set to a numerical value range obtained by appropriately combining the upper limit value and the lower limit value of each numerical value range.

In the present invention, an expression regarding a compound (for example, in a case where a compound is represented by an expression in which “compound” is attached to the end) is used to have a meaning including not only the compound itself but also a salt or an ion thereof. In addition, this expression has a meaning including a derivative obtained by modifying a part of the compound, for example, by introducing a substituent into the compound within a range where the effect of the present invention is not impaired.

A substituent, a linking group, or the like (hereinafter, referred to as “substituent or the like”) is not specified in the present specification regarding whether to be substituted or unsubstituted may have an appropriate substituent. Accordingly, even in a case where a YYY group is simply described in the present invention, this YYY group includes not only an aspect having a substituent but also an aspect not having a substituent. The same shall be applied to a compound that is not specified in the present specification regarding whether to be substituted or unsubstituted. Examples of the preferred examples of the substituent include a substituent Z described later.

In the present invention, in a case where a plurality of substituents or the like represented by a specific reference numeral are present or a plurality of substituents or the like are simultaneously or alternatively defined, the respective substituents or the like may be the same or different from each other. In addition, in a case where a plurality of substituents or the like are adjacent to each other, the substituents may be linked or fused to each other to form a ring unless otherwise specified.

In the present invention, the polymer means a polymer; however, it has the same meaning as a so-called polymeric compound. The polymer includes a homopolymer and a copolymer, and the copolymer includes an addition polymer, a condensation polymer, and the like. A polymerization mode of the constitutional component in the copolymer is not particularly limited and may be random, block, or the like. The polymer may be a crosslinked polymer or a non-crosslinked polymer.

In the present invention, the main chain of each of the polymer and the polymerized chain refers to a linear molecular chain in which all the molecular chains that constitute the polymer or the polymerized chain other than the main chain can be conceived as a branched chain or a pendant group with respect to the main chain. Although it depends on the mass average molecular weight of the branched chain regarded as a branched chain or pendant group, the longest chain among the molecular chains that constitute the polymer or the polymerized chain is typically the main chain. However, the main chain does not include a terminal group that is provided in the terminal of the polymer or the polymerized chain. In addition, side chains of the polymer refer to branched chains other than the main chain and include a short chain and a long chain.

In the present invention, (meth)acryl means one or both of acryl and methacryl. The same applies to (meth)acrylate.

In the present invention, a polymer binder (also simply referred to as a binder) means a binder composed of a polymer and includes a polymer itself and a binder composed (formed) by containing a polymer.

[Electrode Sheet for all-Solid State Secondary Battery]

The electrode sheet for an all-solid state secondary battery according to an embodiment of the present invention (hereinafter, also simply referred to as an “electrode sheet”) is an electrode sheet including an electrode active material layer that contains an inorganic solid electrolyte (B) and an active material (C) on at least one surface of a collector, where the electrode sheet for an all-solid state secondary battery has an insulating polymer anchored portion that contains 50% by mass or more of a polymer (A) having a solubility of 1 g/100 g or more in water at 25° C., at a part of an interface between the collector and the electrode active material layer, that is, on a part of the surface of the collector. As described above, since the polymer anchored portion is disposed on a part of the surface of the collector, the surface planned to be subjected to lamination on which the electrode active material layer is to be provided can be in a state where an insulating polymer anchored portion and an electron conductive portion in which the surface of the collector is exposed are mixedly present. In addition, in a case where the polymer anchored portion is allowed to exhibit a strong interlayer adhesive force with respect to the electrode active material layer, and the electron conductive portion is allowed to maintain the electron conductivity between the two layers and an ion conductivity of a metal belonging to Group 1 or Group 2 in the periodic table (hereinafter, also simply referred to as “ion conductivity”), thereby being allowed to differentiate functions, the collector and the electrode active material layer can be laminated with a strong binding force while ensuring high electron conductivity and ion conductivity. It is not necessary to provide a conductive resin layer between the collector and the electrode active material layer, as in JP2014-093156A, in order to ensure interlayer electron conductivity as described above. Therefore, the electrode sheet can be formed into a thin layer, which also contributes to the reduction in thickness of the all-solid state secondary battery, that is, the improvement in energy density.

In a case where the electrode sheet according to the embodiment of the present invention, which exhibits the above-described excellent characteristics, is incorporated as an electrode of an all-solid state secondary battery, it is possible to realize an all-solid state secondary battery having excellent ion conductivity and excellent cycle characteristics.

The electrode sheet according to the embodiment of the present invention has a collector, an electrode active material layer, and a polymer anchored portion at a part of an interface therebetween.

In the present invention, “the electrode sheet for an all-solid state secondary battery” includes both aspects of an aspect as a constitutional member of an all-solid state secondary battery (a state of being incorporated into a secondary battery) and an aspect as an electrode material which is before being incorporated into an all-solid state secondary battery, as long as it has the configuration defined in the present invention. Accordingly, regarding the form of “the electrode sheet for an all-solid state secondary battery”, forms corresponding to both aspects described above are applied without any particular limitation. For example, it may be sheet-shaped (film-shaped) or strip-shaped. In addition, it may be long or short (a sheet body). In a case of being an electrode material, it is preferable to have a long sheet shape.

It suffices that the electrode sheet according to the embodiment of the present invention has the above-described layer configuration, and the electrode sheet may have another layer (film). Examples of the other layer include a protective layer (a peeling sheet) and a coating layer. Further examples thereof include a base material that supports the electrode sheet. In addition, the electrode sheet according to the embodiment of the present invention can also be a laminate having a solid electrolyte layer on the active material layer and a laminate having another active material layer on the solid electrolyte layer.

The total thickness of the electrode sheet according to the embodiment of the present invention is not particularly limited, and it is, for example, preferably 30 to 500 μm and more preferably 50 to 350 μm. In addition, the thickness of the electrode active material layer in the electrode sheet according to the embodiment of the present invention is not particularly limited. It is appropriately set according to the kind of the battery, the battery performance, and the like, and it is, for example, preferably 10 to 450 μm and more preferably 20 to 300 μm. In a case where the electrode sheet according to the embodiment of the present invention is used as an electrode for an all-solid state secondary battery, the layer thickness of each of the layers forming the electrode sheet according to the embodiment of the present invention is the same as the layer thickness of each of the layers described below regarding the all-solid state secondary battery.

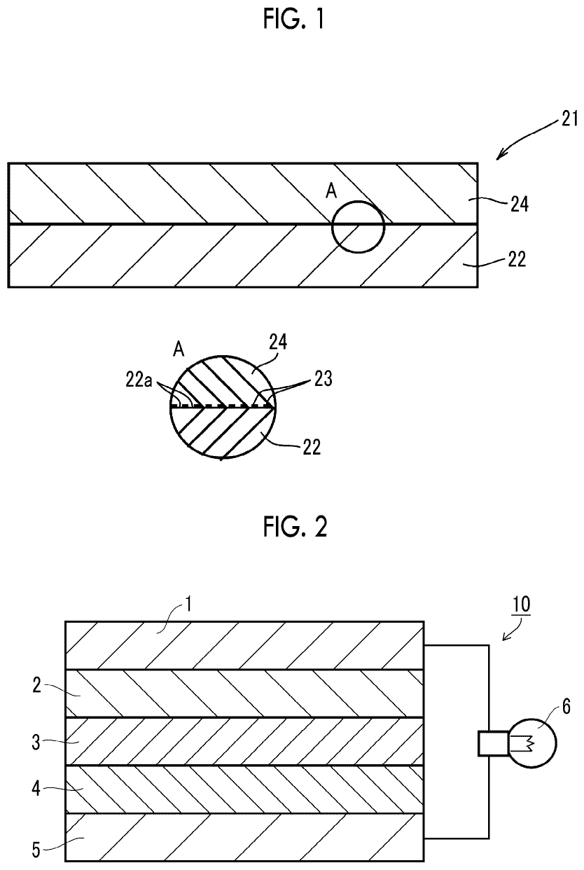

FIG. 1 is a view schematically illustrating a cross section perpendicular to a longitudinal direction of an electrode sheet according to a preferred embodiment of the present invention, and a region A near the interface between a collector and an electrode active material layer in this cross section. An electrode sheet 21 is formed in a long sheet shape, and in a cross section perpendicular to the longitudinal direction thereof, a polymer anchored portion 23 is provided on a part of a surface of a long collector 22, and an electrode active material layer 24 is laminated and disposed in contact with an exposed collector surface 22a (electron conductive portion) and the polymer anchored portion 23. It is noted that even in a cross section parallel to the longitudinal direction of the electrode sheet, a polymer anchored portion is provided on a part of the surface of the collector, and an electrode active material layer is laminated and disposed in contact with the exposed collector surface (electron conductive portion) and the polymer anchored portion in the same manner as described above.

In the present invention, the polymer anchored portion and the electrode active material layer may be provided on the surface of the collector. However, in a case where the electrode sheet according to the embodiment of the present invention is used for an all-solid state secondary battery having a laminated structure in which a plurality of units each consisting of a positive electrode, a solid electrolyte, and a negative electrode are laminated, it is preferable that the polymer anchored portion and the electrode active material layer are provided on both surfaces of the collector.

The electrode sheet according to the embodiment of the present invention may be configured as a positive electrode sheet or as a negative electrode sheet and is appropriately selected depending on the use application and the like. Likewise, the active material layer may be a positive electrode active material layer or a negative electrode active material layer, and the collector may be a positive electrode collector or a negative electrode collector. In the present invention, any one or both of the positive electrode and the negative electrode may be simply referred to as an “electrode”.

### <Polymer Anchored Portion>

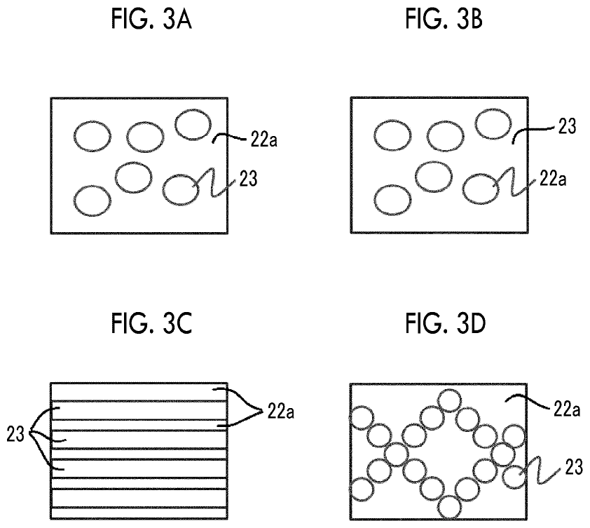

The present invention is made by utilizing characteristics in which the electrode active material layer exhibits electron conductivity and ion conductivity in the layer, and electrons and ions flow concentratively in a conductive portion. Therefore, in the present invention, since the exposed collector surface 22a (electron conductive portion) can ensure the conductivity of electrons and ions as long as it is present on a part of the surface of the collector (the interface between the collector and the electrode active material layer), the disposition amount, disposition pattern, shape, and the like of the electron conductive portion are not particularly limited. That is, in a case of being provided on a part of the surface of the collector, the polymer anchored portion exhibits strong interlayer adhesiveness while maintaining the conductivity of electrons and ions. Therefore, in the present invention, in a case where the polymer anchored portion and the electron conductive portion are provided on the surface of the collector, the disposition pattern and the disposition amount (area proportion) of the polymer anchored portion provided on the surface of the collector are not particularly limited. Examples of the disposition pattern include a straight line pattern (for example, FIG. 3C) in which the polymer anchored portions are disposed regularly or irregularly on the surface of the collector in a plurality of linear shapes in one direction, a pattern (for example, a lattice pattern or a parallel pattern, which is regular or irregular) in which the polymer anchored portions intersect with each other in an intersecting direction, an arrangement (for example, a triangular waveform or a sinusoidal waveform shown in FIG. 3D) in which a mountain-valley shape is repeated regularly or irregularly, a polka dotted pattern (for example, FIGS. 3A and 3B) which is regular or irregular, a regular or irregular zigzag pattern, and an arrangement obtained by combining these patterns. In addition, the shape of the individual polymer anchored portion constituting the above-described alignment pattern is not particularly limited, and examples thereof in planar view include a dot shape such as a circular shape, an elliptical shape (an oval shape), or a quadrangular shape, a linear shape, and an indeterminate shape. In the present invention, as will be described later, the polymer anchored portion and the electron conductive portion are preferably formed randomly in an indeterminate shape in terms of the shape, the arrangement, and the like, by forming a film of the polymer composition. For example, they are preferably formed in an irregular polka dotted shape, in an ununiform state of being finely scattered (blurred), in an uneven state of being blurred in a streaky manner, or the like. The polymer anchored portion and the electron conductive portion are preferably present (scattered, dispersed) over the entire collector (interface), and more preferably present (scattered, dispersed) over the entire surface planned to be subjected to lamination in the collector. However, as described above, it is not necessary that the polymer anchored portion and the electron conductive portion are uniformly present.

It is noted that the presence of the polymer anchored portion (electron conductive portion) can be checked by removing the electrode active material layer as described below and can also be checked by observing the cross section of the electrode sheet. Whether or not a portion is the polymer anchored portion can be confirmed by whether or not carbon atoms are detected by elemental analysis of an observation target using a scanning electron microscope with energy dispersive X-ray spectroscopy (SEM-EDX).

As described above, the electron conductivity can be ensured in a case where the electron conductive portion is present at the interface, and the strong interlayer adhesiveness is exhibited in a case where the polymer anchored portion is present. Therefore, the presence state, the abundance, and the like of the polymer anchored portion and the electron conductive portion at the interface are not particularly limited and can be appropriately set.

For example, in a case where the surface planned to be subjected to lamination is seen in planar view, a proportion of an area S_{P} of the polymer anchored portion to a total surface area S_{A} of the surface planned to be subjected to lamination is determined in consideration of the electron conductivity and the interlayer adhesiveness. In a case of taking an example of the area proportion [(S_{P}/S_{A})×100 (%)], the area proportion [(S_{P}/S_{A})×100 (%)] can be set to, for example, 10% or more and less than 100%, and it is preferably 20% to 80% and more preferably 30% to 80%. The area proportion can be calculated, for example, by removing the electrode active material layer of the electrode sheet and then observing the exposed surface with an electron microscope or the like. The observation magnification is not particularly limited; however, the area of the polymer anchored portion can be calculated by specifying the polymer anchored portion in a predetermined region (region of 100 μm×100 μm) of the surface planned to be subjected to lamination, for example, in a manner as described above, and subjecting an image obtained with a scanning electron microscope (SEM) to image processing, thereby determining the area of the polymer anchored portion. It is noted that a removal method for the electrode active material layer is not particularly limited, and examples thereof include a method of carrying out dissolving, swelling, and the like in various solvents. Examples of the preferred removal method include a method in which the electrode sheet is immersed in a low-polarity solvent such as xylene, a double-sided tape is subsequently attached to a surface of the active material layer opposite to the collector, and the active material layer is peeled off from the collector.

In addition, in a case where the surface planned to be subjected to lamination is seen in planar view, the surface area per one polymer anchored portion and the distance between the polymer anchored portions (the surface area of the electron conductive portion) is not particularly limited either and can be appropriately set. For example, in a case of taking an example of the surface area of the polymer anchored portion, the surface area of the polymer anchored portion can be set to 100 nm² to 100 μm², and in a case of taking an example of the distance between the polymer anchored portions, the distance between the polymer anchored portions can be set to 0.01 to 100 μm as the shortest distance between the two polymer anchored portions that are closest to each other. Both of the surface area of the polymer anchored portion and the distance between the polymer anchored portions are average values from the randomly selected 40 portions and can be calculated in the same manner as the above-described area proportion.

The polymer anchored portion and the electron conductive portion on the surface planned to be subjected to lamination are appropriately set, for example, in terms of the arrangement, the area proportion, and the like of the polymer anchored portions. However, examples of the particularly preferred form in the present invention include a sea-island structure (pattern) in which the polymer anchored portion serves as a “sea” or an “island” and the electron conductive portion serves as an “island” or a “sea”. It is preferable that the sea-island structure spreads over the entire surface planned to be subjected to lamination. The sea-island structure can be formed, for example, by applying and drying a dilute solution for forming a polymer anchored portion with a small coating amount, as described below, or by using a predetermined mask member.

The thickness of the polymer anchored portion is not particularly limited as long as the interlayer adhesiveness is exhibited. In the present invention, since the polymer anchored portion does not need to ensure electron conductivity, the thickness thereof can be reduced, and in this case, it is possible to contribute to the improvement of the energy density of the all-solid state secondary battery. The thickness of the polymer anchored portion can be set to generally 1 to 5,000 nm, and it is preferably 1 to 1,000 nm. The thickness of the polymer anchored portion is determined as an average value of nine polymer anchored portions which are randomly selected from a plurality of the polymer anchored portions present in the observation region. The polymer anchored portion may be a single layer or multiple layers.

The polymer anchored portion contains 50% by mass or more of the polymer (A) having a solubility of 1 g/100 g or more in water at 25° C. and thus exhibits strong interlayer adhesiveness. From the viewpoint of interlayer adhesiveness, the content of the polymer (A) in the polymer anchored portion is preferably 60% by mass or more and more preferably 80% by mass or more. On the other hand, the upper limit of the content of the polymer (A) is not particularly limited and may be 100% by mass. The polymer anchored portion may contain an additive described later, and in this case, the upper limit of the content of the polymer (A) can be set to, for example, 98% by mass or less, and it is preferably 95% by mass or less.

The polymer anchored portion exhibits insulating properties. In the present invention, the insulating properties of the polymer anchored portion can be specified by the surface electrical resistance value thereof, and for example, the surface electrical resistance value can be set to 10⁴Ω/□ or more. The surface electrical resistance value is preferably 10⁸Ω/□ or more and more preferably 10¹²Ω/□ or more. The surface electrical resistance value is determined as a value measured by a method and under conditions described in Examples which will be described later.

In the polymer anchored portion, it is preferable that the residual moisture content is small, where it is, for example, preferably 100 ppm (in terms of mass) or lower. The residual moisture content in the polymer anchored portion can be determined by dissolving the polymer anchored portion in any solvent, subsequently filtering the resultant solution with a membrane filter having a pore size of 0.02 μm, and carrying out Karl Fischer titration.

### (Polymer (A))

The polymer (A) contained in the polymer anchored portion exhibits such hydrophilicity that a solubility (water, 25° C.) in water at 25° C. is 1 g/100 g or more, and it exhibits strong interlayer adhesiveness. In particular, in a case where a hydrophobic dispersion medium is used in the formation of an electrode active material layer described later, the polymer (A) is hardly dissolved in this dispersion medium and remains as a polymer anchored portion, thereby exhibiting strong interlayer adhesiveness. From the viewpoint of interlayer adhesiveness, the solubility (water, 25° C.) of the polymer (A) is preferably 5 g/100 g or more and more preferably 10 g/100 g or more. The upper limit value of the solubility (water, 25° C.) is not particularly limited; however, it is practically 90 g/100 g or less, and preferably 80 g/100 g or less. The solubility (water, 25° C.) of the polymer (A) can be measured according to the method described in Examples.

It is noted that since the polymer (A) exhibits the above-described hydrophilicity, the solubility thereof in toluene at 25° C. (toluene, 25° C.) is preferably less than 1 g/100 g.

The polymer (A) is not particularly limited as long as it is a polymer that has the above-described solubility (water, 25° C.), and examples thereof include an organic polymer or an inorganic polymer, which exhibits various hydrophilic properties or water-soluble properties. Examples thereof include an organic polymer such as polyalkylene glycol, polyvinyl alcohol, a (meth)acrylic polymer, polyacrylamide, a vinyl polymer, a hydrocarbon polymer, nylon, or a cellulose ether, and an inorganic polymer such as organopolysiloxane, where polyalkylene glycol, polyvinyl alcohol, a (meth)acrylic polymer, or a vinyl polymer is preferable, and a (meth)acrylic polymer or a vinyl polymer is more preferable.

The polyalkylene glycol is not particularly limited; however, it is preferably a polymer of an alkylene glycol having 1 to 6 carbon atoms, more preferably a polymer of an alkylene glycol having 1 to 4 carbon atoms, and still more preferably a polymer of ethylene glycol. The polyalkylene glycol may be a copolymer of two or more kinds of alkylene glycols.

The polyvinyl alcohol that is used in the present invention includes a polyvinyl alcohol which is partially saponified or completely saponified, in addition to an unsaponified polyvinyl alcohol.

Examples of the (meth)acrylic polymer include a homopolymer or a copolymer of a (meth)acrylic acid compound and a (meth)acrylic compound (M1) described later. In addition, a copolymer with a vinyl compound (M2) described later is also suitably used. The (meth)acrylic polymer may be contained in a case where it has, in the polymer, 50% by mass or more of a constitutional component derived from the (meth)acrylic acid compound and the (meth)acrylic compound (M1), and has, in the polymer, 50% by mass or less of a constitutional component derived from the vinyl compound (M2).

As the vinyl polymer, a homopolymer or copolymer of a vinyl compound (M2) described later, as well as a copolymer of a (meth)acrylic acid compound, a (meth)acrylic compound (M1), or the like is also suitably used. The vinyl polymer may be contained in a case where it has, in the polymer, 50% by mass or more of a constitutional component derived from the vinyl compound (M2), and has, in the polymer, less than 50% by mass or more of a constitutional component derived from the (meth)acrylic acid compound and the (meth)acrylic compound (M1).

It is preferable that the polymer (A), particularly various polymers other than the hydrophilic polymer such as polyalkylene glycol or polyvinyl alcohol, has the following constitutional component from the viewpoint of exhibiting hydrophilicity and further reinforcing interlayer adhesiveness.

### —Constitutional Component Having Acidic Functional Group or Salt Thereof—

The polymer (A) preferably has the following acidic functional group or a salt thereof, and typically, the main chain of various polymers preferably contains a constitutional component having the following acidic functional group or a salt thereof. In a case where the polymer (A) has the following acidic functional group or the like, the adhesiveness between the polymer anchored portion and the collector is reinforced, and thus it is possible to further reinforce the interlayer adhesiveness.

### <Acidic Functional Group>

A carboxy group, a phosphate group, a phosphonate group, a phosphinate group, and a sulfonate group

Examples of the phosphate group include a group represented by —OP(═O)(OR^{P})₂, examples of the phosphonate group include a group represented by —PO(OR^{P})₂, and examples of the phosphinate group include a group represented by —OP(═O)(R^{P})₂ or —P(═O)H(OR^{P}). In addition, examples of the sulfonate group include a group represented by —S(═O)₂(OR^{P}). Here, R^{P} represents a hydrogen atom or a substituent. The substituent is not particularly limited; however, examples thereof include a group selected from the following substituent Z described later, among which an alkyl group, an aryl group, or the like is preferable.

The above-described acidic functional group may form a salt, and examples of the salt that can be adopted by the acidic functional group include various metal salts, and an ammonium salt or an amine salt, where various metal salts are preferable. In this case, typically, at least one of R^{P}'s described above is dissociated, whereby the acidic functional group becomes an anion, and a salt is formed together with a counter cation. The counter cation is not particularly limited, and examples thereof include various metal cations and a quaternary ammonium cation. The metal cation is not particularly limited, and preferred examples thereof include a cation of a metal belonging to Group 1 or Group 2 in the periodic table. The quaternary ammonium cation is not particularly limited, and examples thereof include an ammonium cation and a tetraalkylammonium cation.

The constitutional component having an acidic functional group or a salt thereof is not particularly limited; however, examples thereof include a constitutional component having an acidic functional group or a salt thereof directly or through a linking group L^{A} that is incorporated into a partial structure of the main chain of the polymer.

The partial structure that is incorporated into the main chain is not unambiguously determined depending on the kind of the polymer (main chain) but is appropriately selected. For example, in a case of a chain polymerization polymer, a carbon chain (a carbon-carbon bond) can be mentioned.

The linking group L^{A} that links the partial structure that is incorporated into the main chain to an acidic functional group or a salt thereof is not particularly limited. However, examples thereof include an alkylene group (preferably having 1 to 12 carbon atoms, more preferably 1 to 6 carbon atoms, and still more preferably having 1 to 3 carbon atoms), an alkenylene group (preferably having 2 to 6 carbon atoms and more preferably having 2 or 3 carbon atoms), an arylene group (preferably having 6 to 24 carbon atoms and more preferably having 6 to 10 carbon atoms), an oxygen atom, a sulfur atom, an imino group (—NR^{N}—: R^{N} represents a hydrogen atom, an alkyl group having 1 to 6 carbon atoms or an aryl group having 6 to 10 carbon atoms), a carbonyl group, a phosphate linking group (—O—P(OH)(O)—O—), a phosphonate linking group (—P(OH)(O)—O—), and a group involved in the combination thereof. Among them, the above-described group is preferably an arylene group alone or a group obtained by combining at least two of an alkylene group, an arylene group, a carbonyl group, an oxygen atom, a sulfur atom, and an imino group, more preferably an arylene group alone or a group obtained by combining at least two of an alkylene group, an arylene group, a carbonyl group, an oxygen atom, a sulfur atom, and an imino group, and still more preferably an arylene group alone or a group containing an —CO—O— group or —CO—N(R^{N})— group (R^{N} is as described above) and an alkylene group.

In the present invention, the number of atoms that constitute the linking group L^{A} is preferably 1 to 36, more preferably 1 to 30, still more preferably 1 to 24, and particularly preferably 3 to 15. The number of linking atoms of the linking group L^{A} is preferably 16 or less, more preferably 12 or less, and still more preferably 10 or less. The lower limit thereof is 1 or more. The number of linking atoms refers to the minimum number of atoms linking predetermined structural moieties. For example, in a case of —O—C(═O)—CH₂—CH₂—, the number of atoms that constitute the linking group is 9; however, the number of linking atoms is 4.

Examples of the constitutional component having an acidic functional group or a salt thereof include a constitutional component derived from a compound in which an acidic functional group or a salt thereof is introduced into a (meth)acrylic compound (M1) or a vinyl compound (M2) which will be described later, and a constitutional component derived from a compound in which an acidic functional group or a salt thereof is directly introduced into a vinyl group.

### —Constitutional Component Having Salt of Basic Functional Group—

The polymer (A) also preferably has a salt of a basic functional group, and typically, it preferably contains a constitutional component having a salt of a basic functional group in the main chain of various polymers. In a case where the polymer (A) has a salt of a basic functional group, the adhesiveness between the polymer anchored portion and the collector is reinforced, and thus it is possible to further reinforce the interlayer adhesiveness.

The basic functional group is not particularly limited. Examples thereof include a group consisting of a nitrogen-containing compound, which includes, for example, an amino group (—N(R^{N1})(R^{N2})), an amidino group (—C(═NR^{N3})—N(R^{N1})(R^{N2})), an imino group (—C(═NR^{N3})—R^{N4}), and a nitrogen-containing ring group obtained by removing one hydrogen atom from a nitrogen-containing ring compound. Here, R^{N1} to R^{N3} represent a hydrogen atom or a substituent. The substituent that can be adopted as R^{N1} to R^{N3} is not particularly limited. Examples thereof include a group selected from the substituent Z described later, where an alkyl group, an aryl group, or the like is preferable, an alkyl group is more preferable, and an alkyl group having 1 to 6 carbon atoms is still more preferable. R^{N4} represents a hydrogen atom or a substituent. The substituent that can be adopted as R^{N4} is not particularly limited. Examples thereof include a group selected from the substituent Z described later, where an alkyl group, an aryl group, or the like is preferable. In a case where all of R^{N1} to R^{N4} take a substituent, they may be the same or different from each other.

Examples of the nitrogen-containing ring compound include a heterocyclic group containing at least one nitrogen atom as a ring-constituting atom, where a 5- or 6-membered heterocyclic group (including an aromatic heterocyclic group and an aliphatic heterocyclic group) having 2 to 20 carbon atoms is preferable. Such a nitrogen-containing compound is preferably an aromatic heterocyclic group, and examples thereof include pyridine, pyrimidine, imidazole, benzimidazole, and triazine. The nitrogen-containing ring compound is preferably pyridine.

The salt of the basic functional group is composed of an ammonium cation obtained by making the above-described basic functional group a quaternary ammonium salt form, and a counter anion. Examples of the ammonium cation include, typically, an ammonium cation obtained by alkylating a basic functional group. The alkyl group to be alkylated is not particularly limited, and it has the same meaning as the alkyl group that can be adopted as R^{N1}. The counter anion is not particularly limited. Examples thereof include anions of various organic acids and inorganic acids, which include anions of inorganic acids, such as a halide ion and a nitrate ion, and anions of organic acids, such as an acetate ion and a sulfonate ion. Among these, a halide ion is preferable, and a chloride ion (Cl⁻), a bromide ion (Br⁻), or an iodide ion (I⁻) is more preferable.

The constitutional component having a salt of a basic functional group is not particularly limited; however, examples thereof include a constitutional component having a salt of a basic functional group directly or through a linking group L^{B} that is incorporated into a partial structure of the main chain of the polymer. Here, the partial structure incorporated into the main chain of the polymer and the linking group L^{B} is the same as the partial structure incorporated into the main chain of the polymer and the linking group L^{A} in the above-described constitutional component having the acidic functional group or a salt thereof.

The constitutional component having a salt of a basic functional group is preferably a constitutional component represented by Formula (N1) or (N2).

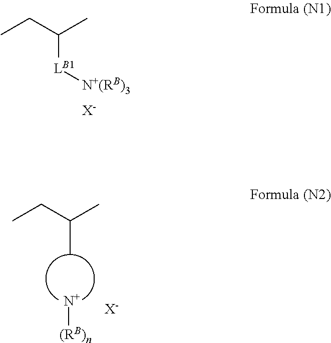

In the formula, L^{B1} represents a single bond or a linking group. The linking group that can be adopted as L^{B1} is not particularly limited; however, it has the same meaning as the above-described linking group L^{B}.

R^{B} represents a hydrogen atom or a substituent. The substituent that can be adopted as R^{B} is not particularly limited; however, it has the same meaning as the substituent that can be adopted as R^{N1}. In each formula, a plurality of R^{B}'s may be the same or different from each other.

The ring including N⁺ in Formula (N2) represents a nitrogen-containing ring group obtained by removing one hydrogen atom from a nitrogen-containing ring compound in order to carry out bonding to a carbon chain. Examples of the nitrogen-containing ring group include a ring group obtained by removing one hydrogen atom from the above-described nitrogen-containing ring compound, where an aromatic heterocyclic group is preferable, and a pyridine ring group is more preferable.

n in Formula (N2) is 1 or 2.

X⁻ in each formula is a counter anion and is as described above.

Examples of the constitutional component having a salt of a basic functional group include a constitutional component derived from a compound in which a salt of a basic functional group is introduced into a (meth)acrylic compound (M1) or a vinyl compound (M2) which will be described later, and a constitutional component derived from a compound in which a salt of a basic functional group is directly introduced into a vinyl group.

### —Another Constitutional Component—

The polymer may have one kind or two or more kinds of constitutional components (referred to as “other constitutional component (Z)”) that do not correspond to any of the above-described constitutional components.

The other constitutional component (Z) is not particularly limited, and examples thereof include a constitutional component derived from an acrylic acid compound, a constitutional component derived from the following (meth)acrylic compound (M1) or vinyl compound (M2), and a constitutional component essential that forms a main chain of various polymers.

Examples of the (meth)acrylic compound (M1) include a (meth)acrylic acid ester compound, a (meth)acrylamide compound, and a (meth)acrylonitrile compound. Among the above, a (meth)acrylic acid ester compound or a (meth)acrylamide compound is preferable.

Examples of the (meth)acrylic acid ester compound include a (meth)acrylic acid alkyl ester compound, a (meth)acrylic acid aryl ester compound, a (meth)acrylic acid ester compound having a heterocyclic group, and a (meth)acrylic acid ester compound having a polymerized chain, where a (meth)acrylic acid alkyl ester compound is preferable. The number of carbon atoms of the alkyl group constituting the (meth)acrylic acid alkyl ester compound is not particularly limited; however, it can be set to, for example, 1 to 24, and it is preferably 1 to 12. Suitable examples of the (meth)acrylic acid alkyl ester compound include a short-chain alkyl ester compound of (meth)acrylic acid, which has 1 to 5 carbon atoms, and a long-chain alkyl ester compound of (meth)acrylic acid, which has 6 to 24 carbon atoms, where these compounds can also be used in combination. The number of carbon atoms of the aryl group that constitutes the aryl ester is not particularly limited; however, it can be set to, for example, 6 to 24, and it is preferably 6 to 10 and more preferably 6. In the (meth)acrylamide compound, the nitrogen atom of the amide group may be substituted with an alkyl group or an aryl group. The polymerized chain contained in the (meth)acrylic acid ester compound is not particularly limited; however, it is preferably an alkylene oxide polymerized chain and more preferably a polymerized chain consisting of an alkylene oxide having 2 to 4 carbon atoms. The degree of polymerization or the number average molecular weight of the polymerized chain is not particularly limited and is appropriately set. For example, in a case of an alkylene oxide polymerized chain, the number average molecular weight can be set to 100 to 2,000. An alkyl group or an aryl group is generally bonded to the end part of the polymerized chain.

In terms of the solubility (water, 25° C.), the (meth)acrylic acid ester compound is preferably a (meth)acrylic acid ester compound of an alkylene oxide polymerized chain.

The vinyl compound (M2) is not particularly limited. However, examples thereof include a vinyl compound copolymerizable with the (meth)acrylic compound (M1) or the like, and preferred examples thereof include an aromatic vinyl compound such as a styrene compound or a vinyl naphthalene compound (excluding a compound consisting of the nitrogen-containing compound and a vinyl group) as well as an allyl compound, a vinyl ether compound, a vinyl ester compound, a dialkyl itaconate compound, and an unsaturated carboxylic acid anhydride. In addition, examples of the vinyl compound also include the “vinyl monomer” described in JP2015-88486A.

The (meth)acrylic compound (M1) and the vinyl compound (M2) are preferably a compound represented by Formula (b-1).

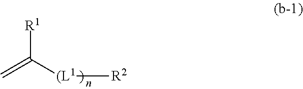

In the formula, R¹ represents a hydrogen atom, a hydroxy group, a cyano group, a halogen atom, an alkyl group (preferably having 1 to 24 carbon atoms, more preferably 1 to 12 carbon atoms, and particularly preferably 1 to 6 carbon atoms), an alkenyl group (preferably having 2 to 24 carbon atoms, more preferably 2 to 12 carbon atoms, and particularly preferably 2 to 6 carbon atoms), an alkynyl group (preferably having 2 to 24 carbon atoms, more preferably 2 to 12 carbon atoms, and particularly preferably 2 to 6 carbon atoms), or an aryl group (preferably having 6 to 22 carbon atoms and more preferably 6 to 14 carbon atoms). Among the above, a hydrogen atom or an alkyl group is preferable, and a hydrogen atom or a methyl group is more preferable.

R² represents a hydrogen atom or a substituent. The substituent that can be adopted as R² is not particularly limited; however, examples thereof include a group selected from the substituent Z described later. Preferred examples of the substituent that can be adopted as R² include an alkyl group (preferably having 1 to 24 carbon atoms, more preferably having 1 to 12 carbon atoms, and particularly preferably having 1 to 6 carbon atoms), an alkenyl group (preferably having 2 to 12 carbon atoms and more preferably 2 to 6 carbon atoms), an aryl group (having preferably 6 to 22 carbon atoms and more preferably 6 to 14 carbon atoms), an aralkyl group (having preferably 7 to 23 carbon atoms and more preferably 7 to 15 carbon atoms), a cyano group, a hydroxy group, and a thiol group.

L¹ represents a linking group and examples thereof include the linking group L^{A}.

n is 0 or 1 and preferably 1. However, in a case where-(L′)ₙ—R² represents one kind of substituent (for example, an alkyl group), n is set to 0, and R² is set to a substituent (an alkyl group).

The (meth)acrylic compound (M1) is preferably a compound represented by Formula (b-2) or (b-3).

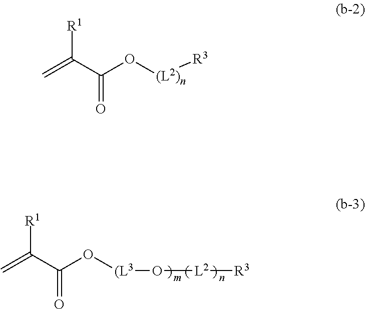

R¹ and n respectively have the same meanings as those in Formula (b-1).

R³ has the same meaning as R².

L² is a linking group and has the same meaning as the above L¹.

L³ is a linking group and has the same meaning as the above L¹; however, it is preferably an alkylene group having 1 to 6 carbon atoms (preferably 2 to 4).

m is preferably an integer of 1 to 200, more preferably an integer of 1 to 100, and still more preferably an integer of 1 to 50.

In Formulae (b-1) to (b-3), the carbon atom which forms a polymerizable group and to which R¹ is not bonded is represented as an unsubstituted carbon atom (H₂C=); however, it may have a substituent. The substituent is not particularly limited; however, examples thereof include the above group that can be adopted as R¹.

Further, in Formulae (b-1) to (b-3), the group which may adopt a substituent such as an alkyl group, an aryl group, an alkylene group, or an arylene group may have a substituent within a range where the effect of the present invention is not impaired. The substituent is not particularly limited, and examples thereof include a group selected from the substituent Z described later, where specific examples thereof include a halogen atom.

Specific examples of the (meth)acrylic compound (M1) and the vinyl compound (M2) include compounds from which constitutional components in the linear polymer are derived, where the polymers will be described later and are those in Examples; however, the present invention is not limited thereto.

Examples of the substituent Z include the following ones.

Examples thereof include an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, for example, vinyl, allyl, or oleyl), an alkynyl group (preferably an alkynyl group having 2 to 20 carbon atoms, for example, ethynyl, butadiynyl, or phenyl-ethynyl), a cycloalkyl group (preferably a cycloalkyl group having 3 to 20 carbon atoms, for example, cyclopropyl, cyclopentyl, cyclohexyl, or 4-methylcyclohexyl; although the meaning of the alkyl group described in the present invention typically include a cycloalkyl group, the alkyl group and the cycloalkyl group are separately described here), an aryl group (preferably an aryl group having 6 to 26 carbon atoms, for example, phenyl, 1-naphthyl, 4-methoxyphenyl, 2-chlorophenyl, or 3-methylphenyl), an aralkyl group (preferably an aralkyl group having 7 to 23 carbon atoms, for example, benzyl or phenethyl), a heterocyclic group (preferably a heterocyclic group having 2 to 20 carbon atoms and more preferably a 5- or 6-membered heterocyclic group having at least one oxygen atom, one sulfur atom, or one nitrogen atom; the heterocyclic group includes an aromatic heterocyclic group and an aliphatic heterocyclic group; for example, a tetrahydropyran ring group, a tetrahydrofuran ring group, a 2-pyridyl group, a 4-pyridyl group, a 2-imidazolyl group, a 2-benzimidazolyl group, a 2-thiazolyl group, a 2-oxazolyl group, or a pyrrolidone group), an alkoxy group (preferably an alkoxy group having 1 to 20 carbon atoms, for example, methoxy, ethoxy, isopropyloxy, or benzyloxy), an aryloxy group (preferably an aryloxy group having 6 to 26 carbon atoms, for example, phenoxy, 1-naphthyloxy, 3-methylphenoxy, or 4-methoxyphenoxy), a heterocyclic oxy group (a group in which an —O— group is bonded to the above-described heterocyclic group), an alkoxycarbonyl group (preferably an alkoxycarbonyl group having 2 to 20 carbon atoms, for example, ethoxycarbonyl, 2-ethylhexyloxycarbonyl, or dodecyloxycarbonyl), an aryloxycarbonyl group (preferably an aryloxycarbonyl group having 6 to 26 carbon atoms, for example, phenoxycarbonyl, 1-naphthyloxycarbonyl, 3-methylphenoxycarbonyl, or 4-methoxyphenoxycarbonyl), a heterocyclic oxycarbonyl group (a group in which an —O—CO— group is bonded to the above-described heterocyclic group), an amino group (preferably an amino group having 0 to 20 carbon atoms, an alkylamino group, or an arylamino group, for example, amino (—NH₂), N,N-dimethylamino, N,N-diethylamino, N-ethylamino, or anilino), a sulfamoyl group (preferably a sulfamoyl group having 0 to 20 carbon atoms, for example, N,N-dimethylsulfamoyl or N-phenylsufamoyl), an acyl group (including an alkylcarbonyl group, an alkenylcarbonyl group, an alkynylcarbonyl group, an arylcarbonyl group, and a heterocyclic carbonyl group; preferably an acyl group having 1 to 20 carbon atoms, for example, acetyl, propionyl, butyryl, octanoyl, hexadecanoyl, acryloyl, methacryloyl, crotonoyl, benzoyl, a naphthoyl, or nicotinoyl), an acyloxy group (including an alkylcarbonyloxy group, an alkenylcarbonyloxy group, an alkynylcarbonyloxy group, and a heterocyclic carbonyloxy group; preferably an acyloxy group having 1 to 20 carbon atoms, for example, acetyloxy, propionyloxy, butyryloxy, octanoyloxy, hexadecanoyloxy, acryloyloxy, methacryloyloxy, crotonoyloxy, or nicotinoyloxy), an aryloyloxy group (preferably an aryloyloxy group having 7 to 23 carbon atoms, for example, benzoyloxy or naphthoyloxy), a carbamoyl group (preferably a carbamoyl group having 1 to 20 carbon atoms, for example, N,N-dimethylcarbamoyl or N-phenylcarbamoyl), an acylamino group (preferably an acylamino group having 1 to 20 carbon atoms, for example, acetylamino or benzoylamino), an alkylthio group (preferably an alkylthio group having 1 to 20 carbon atoms, for example, methylthio, ethylthio, isopropylthio, or benzylthio), an arylthio group (preferably an arylthio group having 6 to 26 carbon atoms, for example, phenylthio, 1-naphthylthio, 3-methylphenylthio, or 4-methoxyphenylthio), a heterocyclic thio group (a group in which an —S— group is bonded to the above-described heterocyclic group), an alkylsulfonyl group (preferably an alkylsulfonyl group having 1 to 20 carbon atoms, for example, methylsulfonyl or ethylsulfonyl), an arylsulfonyl group (preferably an arylsulfonyl group having 6 to 22 carbon atoms, for example, benzenesulfonyl), an alkylsilyl group (preferably an alkylsilyl group having 1 to 20 carbon atoms, for example, monomethylsilyl, dimethylsilyl, trimethylsilyl, or triethylsilyl), an arylsilyl group (preferably an arylsilyl group having 6 to 42 carbon atoms, for example, triphenylsilyl), an alkoxysilyl group (preferably an alkoxysilyl group having 1 to 20 carbon atoms, for example, monomethoxysilyl, dimethoxysilyl, trimethoxysilyl, or triethoxysilyl), an aryloxysilyl group (preferably an aryloxysilyl group having 6 to 42 carbon atoms, for example, triphenyloxysilyl), a phosphoryl group (preferably a phosphate group having 0 to 20 carbon atoms, for example, —OP(═O)(OR^{P})₂), a phosphonyl group (preferably a phosphonyl group having 0 to 20 carbon atoms, for example, —P(═O)(OR^{P})₂), a phosphinyl group (preferably a phosphinyl group having 0 to 20 carbon atoms, for example, —P(R^{P})₂), a sulfo group (a sulfonate group), a carboxy group, a hydroxy group, a sulfanyl group, a cyano group, and a halogen atom (for example, a fluorine atom, a chlorine atom, a bromine atom, or an iodine atom). R^{P} represents a hydrogen atom or a substituent (preferably a group selected from the substituent Z).

In addition, each group exemplified in the substituent Z may be further substituted with the substituent Z described above.

The alkyl group, the alkylene group, the alkenyl group, the alkenylene group, the alkynyl group, the alkynylene group, and the like may be cyclic or chained, may be linear or branched.

The content of each constitutional component in the polymer is not particularly limited, and it is determined by appropriately considering the physical properties of the entire polymer, for example, the solubility in water, and it is set, for example, in the following range.

The content of each constitutional component in the polymer is set, for example, in the following range such that the total content of all the constitutional components is 100% by mass.

It is noted that in a case where the polymer has a plurality of specific constitutional components, the content of the constitutional components is defined as the total content thereof.

The content of the constitutional component having an acidic functional group or a salt thereof is not particularly limited; however, it can be appropriately adjusted in consideration of the solubility, the interlayer adhesiveness, and the like. The content of the constitutional component having an acidic functional group or a salt thereof is, for example, preferably 0% to 80% by mass, more preferably 0% to 50% by mass, still more preferably 0.1% to 40% by mass, and particularly preferably 25% to 40% by mass with respect to the total content of all the constitutional components.

The content of the constitutional component having a salt of a basic functional group is not particularly limited; however, it can be appropriately adjusted in consideration of the solubility, the interlayer adhesiveness, and the like. The content of the constitutional component having a salt of a basic functional group is, for example, preferably 0% to 80% by mass, more preferably 2% to 60% by mass, and still more preferably 5% to 50% by mass with respect to the total content of all the constitutional components.

The content of the other constitutional component (Z) is not particularly limited; however, it can be appropriately adjusted in consideration of the solubility, the interlayer adhesiveness, and the like. The content of the other constitutional component (Z) is, for example, preferably 0% to 99% by mass, more preferably 10% to 98% by mass, still more preferably 20% to 95% by mass, and even still more preferably 20% to 75% by mass with respect to the total content of all the constitutional components.

### —Physical Properties, Characteristics, and the Like of Polymer (A)—

The polymer (A) that is used in the present invention preferably has physical properties, characteristics, and the like which are described below.

The mass average molecular weight of the polymer is not particularly limited. It is, for example, preferably 5,000 or more, more preferably 30,000 or more, and still more preferably 50,000 or more. The upper limit thereof is practically 5,000,000 or less, preferably 500,000 or less, more preferably 300,000 or less, and still more preferably 200,000 or less.

The mass average molecular weight of the polymer can be appropriately adjusted by changing the kind, content, polymerization time, polymerization temperature, and the like of the polymerization initiator.

### —Measurement of Molecular Weight—

In the present invention, unless otherwise specified, the molecular weight of the polymer or the polymerized chain (a constitutional component having a polymerized chain) refers to a mass average molecular weight and number average molecular weight in terms of standard polystyrene conversion, which are determined by gel permeation chromatography (GPC). The measuring method thereof includes, basically, a method in which conditions are set to Conditions 1 or Conditions 2 (preferential) described below. However, depending on the kind of polymer or polymerized chain a suitable eluent may be appropriately selected and used.

### (Condition 1)

Column: Connect two TOSOH TSKgel Super AWM-H (product name, manufactured by Tosoh Corporation)
Carrier: 10 mM LiBr/N-methylpyrrolidone
Measurement temperature: 40° C.
Carrier flow rate: 1.0 ml/min
Sample concentration: 0.1% by mass
Detector: refractive index (RI) detector

### (Condition 2)

Column: A column obtained by connecting TOSOH TSKgel Super HZM-H, TOSOH TSKgel Super HZ4000, and TOSOH TSKgel Super HZ2000 (all of which are product names, manufactured by Tosoh Corporation)
Carrier: tetrahydrofuran
Measurement temperature: 40° C.
Carrier flow rate: 1.0 ml/min
Sample concentration: 0.1% by mass
Detector: refractive index (RI) detector

The moisture concentration of the polymer is preferably 100 ppm (in terms of mass) or lower. In addition, the polymer may be dried by crystallization, or the polymer liquid may be used as it is.

The polymer is preferably amorphous. In the present invention, the description that a polymer is “noncrystalline” typically refers to that no endothermic peak due to crystal melting is observed in a case where the measurement is carried out at the glass transition temperature.

The polymer may be a non-crosslinked polymer or a crosslinked polymer. In addition, in a case where the crosslinking of the polymer progresses due to heating or voltage application, the molecular weight may be higher than the above-described molecular weight. Preferably, the polymer has a mass average molecular weight in the above-described range at the start of use of the all-solid state secondary battery.

The polymer (A) contained in the polymer anchored portion may be one kind or two or more kinds.

The content of the polymer (A) in the polymer anchored portion may be 50% by mass or more; however, it is preferably 60% to 100% by mass, more preferably 70% to 100% by mass, and still more preferably 85% to 100% by mass, in terms of the adhesiveness to the collector.

### (Additive)

The polymer anchored portion may contain a polymer having a solubility (water, 25° C.) of less than 1 g/100 g and various additives, as components other than the polymer (A). The additive is not particularly limited; however, examples thereof include insulating particles, a crosslinking agent, a pressure sensitive adhesiveness imparting resin, and a silane coupling agent. Examples of the insulating particles include particles of an inorganic filler such as silica, aluminum oxide, or titanium oxide, and particles of various resins. Examples of the crosslinking agent, the pressure sensitive adhesiveness imparting resin, and the silane coupling agent include those described in paragraph [0031] of JP2014-093156A.

The polymer anchored portion may contain conductive particles (for example, conductive fine particles described in paragraph [0022] of JP2014-093156A); however, it is preferable that the polymer anchored portion does not contain conductive particles. In the present invention, the description that the polymer anchored portion does not contain conductive particles includes an aspect in which the polymer anchored portion does not exhibit conductivity as a whole, that is, the conductive particles are contained such that the content thereof does not allow the polymer anchored portion to construct a conductive path between layers, or the content thereof allows the surface electrical resistance to satisfy the above-described range.

The total content of the polymer having a solubility (water, 25° C.) of less than 1 g/100 g and the additive in the polymer anchored portion is appropriately set, and it can be set to, for example, 50% by mass or less, and it is preferably 40% by mass or less, more preferably 30% by mass or less, and still more preferably 15% by mass or less. The content of the polymer having a solubility (water, 25° C.) of less than 1 g/100 g can be, for example, 50% by mass or less, and the total content of the above-described additive can be set to, for example, 30% by mass or less.

### <Collector>

A collector that constitutes the electrode sheet according to the embodiment of the present invention is not particularly limited as long as it is typically used for a secondary battery, and it is preferably an electron conductor. Examples of the material that forms the collector include a metal or a conductive resin, and it is preferable that an appropriate material is selected depending on the use application (a positive electrode collector or a negative electrode collector) of the collector. For example, in a case where the collector is used as a positive electrode collector, examples of the material of the positive electrode collector include not only aluminum, an aluminum alloy, stainless steel, nickel, and titanium but also a material (a material on which a thin film has been formed) obtained by treating a surface of aluminum or stainless steel with carbon, nickel, titanium, or silver, among which, aluminum or an aluminum alloy is preferable. On the other hand, in a case where the collector is used as a negative electrode collector, examples of the material of the negative electrode collector include not only aluminum, copper, a copper alloy, stainless steel, nickel, and titanium but also a material obtained by treating a surface of aluminum, copper, a copper alloy, or stainless steel with carbon, nickel, titanium, or silver, among which copper, a copper alloy, or stainless steel is more preferable.

Regarding the shape of the collector, a film sheet shape is typically used; however, it is also possible to use a collector having a shape a net shape or a punched shape, or a collector of a lath body, a porous body, a foaming body, a molded body of a fiber group, or the like.

The thickness of the collector is not particularly limited as long as the total thickness of the electrode sheet satisfies the above-described range, and for example, it is preferably 1 to 50 m and more preferably 3 to 30 μm.

It is also preferable that the surface of the collector is made to be uneven through a surface treatment.

In the present invention, any one of the positive electrode collector or the negative electrode collector, or collectively both of them may be simply referred to as the collector.

### <Electrode Active Material Layer>

An electrode active material layer (hereinafter, also referred to as an active material layer) included in the electrode sheet according to the embodiment of the present invention contains an inorganic solid electrolyte (B), an active material (C), preferably a binder (D), preferably a conductive auxiliary agent, and various additives and the like as appropriate.

In the present invention, any one of the positive electrode active material layer and the negative electrode active material layer, or collectively both of them may be simply referred to as the electrode active material layer.

### <Inorganic Solid Electrolyte (B)>

The active material layer contains an inorganic solid electrolyte.

In the present invention, the inorganic solid electrolyte is an inorganic solid electrolyte, where the solid electrolyte refers to a solid-shaped electrolyte capable of migrating ions therein. The inorganic solid electrolyte is clearly distinguished from the organic solid electrolyte (the polymeric electrolyte such as polyethylene oxide (PEO) or the organic solid electrolyte salt such as lithium bis(trifluoromethanesulfonyl)imide (LiTFSI)) since it does not include any organic substance as a principal ion-conductive material. In addition, the inorganic solid electrolyte is solid in a steady state and thus, typically, is not dissociated or liberated into cations and anions. In terms of this fact, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has an ion conductivity of a metal belonging to Group 1 or Group 2 in the periodic table and generally does not have electron conductivity. In a case where the all-solid state secondary battery according to the embodiment of the present invention is a lithium ion battery, the inorganic solid electrolyte preferably has a lithium ion conductivity.

As the inorganic solid electrolyte, a solid electrolyte material that is typically used for an all-solid state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. The sulfide-based inorganic solid electrolytes are preferably used from the viewpoint that it is possible to form a more favorable interface between the active material and the inorganic solid electrolyte.

### (i) Sulfide-Based Inorganic Solid Electrolyte

The sulfide-based inorganic solid electrolyte is preferably an electrolyte that contains a sulfur atom, has an ion conductivity of a metal belonging to Group 1 or Group 2 in the periodic table, and has electron-insulating properties. The sulfide-based inorganic solid electrolytes are preferably inorganic solid electrolytes which contain, as elements, at least Li, S, and P and have a lithium ion conductivity; however, the sulfide-based inorganic solid electrolytes may appropriately include elements other than Li, S, and P.

Examples of the sulfide-based inorganic solid electrolyte include a lithium ion-conductive inorganic solid electrolyte satisfying the composition represented by Formula (1).

Lₐ₁M_{b1}P_{c1}S_{d1}Aₑ₁ (1)

In the formula, L represents an element selected from Li, Na, or K and is preferably Li. M represents an element selected from B, Zn, Sn, Si, Cu, Ga, Sb, Al, or Ge. A represents an element selected from I, Br, Cl, or F. a1 to e1 represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios among the respective elements can be controlled by adjusting the amounts of raw material compounds blended to manufacture the sulfide-based inorganic solid electrolyte as described below.

The sulfide-based inorganic solid electrolyte may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two or more raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M described above (for example, SiS₂, SnS, and GeS₂).

The ratio between Li₂S and P₂S₅ in each of Li—P—S-based glass and Li—P—S-based glass ceramic is preferably 60:40 to 90:10 and more preferably 68:32 to 78:22 in terms of the molar ratio between Li₂S:P₂S₅. In a case where the ratio between Li₂S and P₂S₅ is set in the above-described range, it is possible to increase a lithium ion conductivity. Specifically, the lithium ion conductivity can be preferably set to 1×10⁻⁴ S/cm or more and more preferably set to 1×10⁻³ S/cm or more. The upper limit is not particularly limited; however, it is realistically 1×10⁻¹ S/cm or lower.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, and Li₁₀GeP₂Si₂. The mixing ratio between the individual raw materials does not matter. Examples of the method of synthesizing a sulfide-based inorganic solid electrolyte material using the above-described raw material compositions include an amorphorization method. Examples of the amorphorization method include a mechanical milling method, a solution method, and a melting quenching method. This is because treatments at a normal temperature become possible, and it is possible to simplify manufacturing processes.

### (ii) Oxide-Based Inorganic Solid Electrolyte

The oxide-based inorganic solid electrolyte is preferably an electrolyte that contains an oxygen atom, has an ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit is not particularly limited; however, it is practically 1×10⁻¹ S/cm or less.

Specific examples of the compound include LiₓₐLa_{ya}TiO₃ (LLT) [xa satisfies 0.3≤xa≤0.7, and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{cc}_{zc}O_{nc} (MC is one or more elements selected from C, S, Al, Si, Ga, Ge, In, and Sn, xc satisfies 0≤xc≤5, ye satisfies 0≤ye≤1, zc satisfies 0≤zc≤1, and nc satisfies 0≤nc≤6); Li_{xd}(Al, Ga)^{yd}(Ti, Ge)_{zd}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13); Li₍₃₋₂ₓₑ₎M^{ee}ₓₑD^{ee}O (xe represents a number of 0 or more and 0.1 or less, M^{ee} represents a divalent metal atom, and D^{ee} represents a halogen atom or a combination of two or more halogen atoms); Li_{xf}Si_{yf}O_{zf} (xf satisfies 1≤xf≤5, yf satisfies 0≤yf≤3, and zf satisfies 1≤zf≤10); Li_{xg}S_{yg}O_{zg} (xg satisfies 1≤xg≤3, yg satisfies 0≤yg≤2, and zg satisfies 1≤zg≤10); Li₃BO₃; Li₃BO₃—Li₂SO₄; Li₂O—B₂O₃—P₂O₅; Li₂O—SiO₂; Li₆BaLa₂Ta₂O₁₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓₕSi_{yh}P_{3-yh}O₁₂ (xh satisfies 0≤xh≤1, and yh satisfies 0≤yh≤1); and Li₇La₃Zr₂O₁₂ (LLZ) having a garnet-type crystal structure.

In addition, a phosphorus compound containing Li, P, or O is also desirable. Examples thereof include lithium phosphate (Li₃PO₄); LiPON in which a part of oxygen elements in lithium phosphate are substituted with a nitrogen element; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Further, it is also possible to preferably use LiA¹ON (A¹ is one or more elements selected from Si, B, Ge, Al, C, and Ga).

(iii) Halide-Based Inorganic Solid Electrolyte

The halide-based inorganic solid electrolyte is preferably a compound that contains a halogen atom, has an ion conductivity of a metal belonging to Group 1 or Group 2 in the periodic table, and has electron-insulating properties.

The halide-based inorganic solid electrolyte is not particularly limited; however, examples thereof include LiCl, LiBr, LiI, and compounds such as Li₃YBr₆ or Li₃YCl₆ described in ADVANCED MATERIALS, 2018, 30, 1803075. In particular, Li₃YBr₆ or Li₃YCl₆ is preferable.

### (iv) Hydride-Based Inorganic Solid Electrolyte

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited; however, examples thereof include LiBH₄, Li₄(BH₄)₃I, and 3LiBH₄—LiCl.

The inorganic solid electrolyte is preferably particulate. In this case, the particle diameter (the volume average particle diameter) of the inorganic solid electrolyte is not particularly limited; however, it is preferably 0.01 μm or more and more preferably 0.1 μm or more. The upper limit is preferably 100 μm or less and more preferably 50 μm or less.

The particle diameter of the inorganic solid electrolyte is measured according to the following procedure. Using water (heptane in a case where the inorganic solid electrolyte is unstable in water), the inorganic solid electrolyte particles are diluted in a 20 mL sample bottle to prepare 1% by mass of a dispersion liquid. The diluted dispersion liquid sample is irradiated with 1 kHz ultrasonic waves for 10 minutes and is then immediately used for testing. Data collection is carried out 50 times using this dispersion liquid sample, a laser diffraction/scattering-type particle size distribution analyzer LA-920 (product name, manufactured by Horiba Ltd.), and a quartz cell for measurement at a temperature of 25° C. to obtain the volume average particle diameter. For other detailed conditions and the like, Japanese Industrial Standards (JIS) Z8828: 2013 “particle diameter Analysis-Dynamic Light Scattering” is referred to as necessary. Five samples per level are produced, and the average values therefrom are employed.

One kind of the inorganic solid electrolyte may be used alone, or two or more kinds thereof may be used in combination.

In the active material layer, the total mass (mg) (mass per unit area) of the inorganic solid electrolyte and the active material per unit area (cm²) is not particularly limited. It can be appropriately determined according to the designed battery capacity and can be set to, for example, 1 to 100 mg/cm².

In terms of dispersibility, reduction of interface resistance, and binding property, the content of the inorganic solid electrolyte in the active material layer is preferably 50% by mass or more, more preferably 70% by mass or more, and particularly preferably 90% by mass or more in 100% by mass of the solid content, in terms of the total content of the inorganic solid electrolyte and the active material to be used in combination. From the same viewpoint, the upper limit thereof is preferably 99.9% by mass or less, more preferably 99.5% by mass or less, and particularly preferably 99% by mass or less.

### <Active Material (C)>

The active material is a material that is capable of intercalating and deintercalating an ion of a metal belonging to Group 1 or Group 2 in the periodic table. Examples of such an active material include a positive electrode active material and a negative electrode active material, which will be described below, and the active material layer contains a positive electrode active material or a negative electrode active material depending on the use application of the electrode according to the embodiment of the present invention.

The positive electrode active material is preferably a transition metal oxide. As the negative electrode active material, a metal oxide or a metal such as Sn, Si, Al, or In capable of forming an alloy with lithium is preferable.

In the present invention, any one of the positive electrode active material and the negative electrode active material, or collectively both of them may be simply referred to as an active material or an electrode active material.

### (Positive Electrode Active Material)

The positive electrode active material is an active material that is capable of intercalating and deintercalating an ion of a metal belonging to Group 1 or Group 2 of the periodic table, and it is preferably one capable of reversibly intercalating and deintercalating a lithium ion. The above-described material is not particularly limited as long as it has the above-described characteristics, and the material may be a transition metal oxide, an organic substance, an element capable of being complexed with Li, such as sulfur, or the like.

Among the above, as the positive electrode active material, transition metal oxides are preferably used, and transition metal oxides having a transition metal element M^{a} (one or more elements selected from Co, Ni, Fe, Mn, Cu, and V) are more preferable. In addition, an element M^{b} (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The mixing amount is preferably 0% to 30% by mol of the amount (100% by mol) of the transition metal element M^{a}. It is more preferable that the transition metal oxide is synthesized by mixing the above components such that a molar ratio Li/M^{a} is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME).

Specific examples of the transition metal oxides having a bedded salt-type structure (MA) include LiCoO₂ (lithium cobalt oxide [LCO]), LiNi₂O₂ (lithium nickel oxide) LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickel oxide).

Specific examples of the transition metal oxides having a spinel-type structure (MB) include LiMn₂O₄(LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃ (lithium vanadium phosphate).

Examples of the lithium-containing transition metal halogenated phosphoric acid compound (MD) include an iron fluorophosphate such as Li₂FePO₄F, a manganese fluorophosphate such as Li₂MnPO₄F, and a cobalt fluorophosphate such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

The shape of the positive electrode active material is not particularly limited but is preferably a particulate shape. A (volume average) particle diameter (volume average particle diameter in terms of sphere) of the positive electrode active material is not particularly limited. For example, it can be set to 0.1 to 50 μm. In order to allow the positive electrode active material to have a predetermined particle diameter, a typical pulverizer or classifier may be used. A positive electrode active material obtained using a baking method may be used after being washed with water, an acidic aqueous solution, an alkaline aqueous solution, or an organic solvent. The particle diameter of the positive electrode active material particles can be measured in the same manner as the measurement of the particle diameter of the inorganic solid electrolyte.

One kind of the positive electrode active material may be used alone, or two or more kinds thereof may be used in combination.

In a case of forming a positive electrode active material layer, the mass (mg) (mass per unit area) of the positive electrode active material per unit area (cm²) in the positive electrode active material layer is not particularly limited. It can be appropriately determined according to the designed battery capacity and can be set to, for example, 1 to 100 mg/cm².

The content of the positive electrode active material in the active material layer is not particularly limited; however, it is preferably 10% to 97% by mass, more preferably 30% to 95% by mass, still more preferably 40% to 93% by mass, and particularly preferably 50% to 90% by mass.

### (Negative Electrode Active Material)

The negative electrode active material is an active material that is capable of intercalating and deintercalating an ion of a metal belonging to Group 1 or Group 2 of the periodic table, and it is preferably one capable of reversibly intercalating and deintercalating a lithium ion. The material is not particularly limited as long as it has the above-described characteristics, and examples thereof include a carbonaceous material, a metal oxide, a metal composite oxide, a lithium single body, a lithium alloy, and a negative electrode active material that is capable of an alloy (capable of being alloyed) with lithium. Among the above, a carbonaceous material, a metal composite oxide, or a lithium single body is preferably used from the viewpoint of reliability. An active material that is capable of being alloyed with lithium is preferable since the capacity of the all-solid state secondary battery can be increased.

The carbonaceous material that is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by baking a variety of synthetic resins such as polyacrylonitrile (PAN)-based resins or furfuryl alcohol resins. Further, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the lattice spacing, density, and crystallite size described in JP1987-22066A (JP-S62-22066A), JP1990-6856A (JP-H2-6856A), and JP1991-45473A (JP-H3-45473A). The carbonaceous material is not necessarily a single material and, for example, may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element that is applied as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (a metalloid oxide). The oxides are preferably noncrystalline oxides, and preferred examples thereof include chalcogenides which are reaction products between metal elements and elements in Group 16 of the periodic table. In the present invention, the metalloid element refers to an element having intermediate properties between those of a metal element and a non-metalloid element. Typically, the metalloid elements include six elements including boron, silicon, germanium, arsenic, antimony, and tellurium, and further include three elements including selenium, polonium, and astatine. In addition, “noncrystalline” represents an oxide having a broad scattering band with an apex in a range of 20° to 40° in terms of 20 value in case of being measured by an X-ray diffraction method using CuKα rays, and the oxide may have a crystalline diffraction line. The highest intensity in a crystalline diffraction line observed in a range of 400 to 700 in terms of 20 value is preferably 100 times or less and more preferably 5 times or less with respect to the intensity of a diffraction line at the apex in a broad scattering band observed in a range of 200 to 400 in terms of 20 value, and it is particularly preferable that the oxide does not have a crystalline diffraction line.

In the compound group consisting of the noncrystalline oxides and the chalcogenides, noncrystalline oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IJIB) to 15 (VB) in the periodic table or chalcogenides are particularly preferable. Specific examples of the preferred noncrystalline oxide and chalcogenide preferably include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Suitable examples of the negative electrode active material which can be used in combination with a noncrystalline oxide containing Sn, Si, or Ge as a major component include a carbonaceous material capable of intercalating and/or deintercalating lithium ions or lithium metal, a lithium single body, a lithium alloy, and a negative electrode active material that is capable of being alloyed with lithium.

It is preferable that an oxide of a metal or a metalloid element, in particular, a metal (composite) oxide and the chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable since the volume variation during the intercalation and deintercalation of lithium ions is small, and thus the high-speed charging and discharging characteristics are excellent, and the deterioration of electrodes is suppressed, whereby it becomes possible to improve the life of the lithium ion secondary battery.

The lithium alloy as the negative electrode active material is not particularly limited as long as it is typically used as a negative electrode active material for a secondary battery, and examples thereof include a lithium aluminum alloy, and specifically, a lithium aluminum alloy, using lithium as a base metal, to which 10% by mass of aluminum is added.

The negative electrode active material capable of forming an alloy with lithium is not particularly limited as long as it is typically used as a negative electrode active material for a secondary battery. Such an active material has a large expansion and contraction due to charging and discharging of the all-solid state secondary battery and accelerates the deterioration of cycle characteristics. However, the deterioration of cycle characteristics can be suppressed since the inorganic solid electrolyte-containing composition according to the embodiment of the present invention contains a binder described later, and since the electrode sheet for an all-solid state secondary battery according to the embodiment of the present invention has the polymer anchored portion. Examples of such an active material include a (negative electrode) active material (an alloy or the like) having a silicon element or a tin element and a metal such as Al or In, a negative electrode active material (a silicon element-containing active material) having a silicon element capable of exhibiting high battery capacity is preferable, and a silicon element-containing active material in which the content of the silicon element is 50% by mole or more with respect to all the constitutional elements is more preferable.

In general, a negative electrode including the negative electrode active material (for example, a Si negative electrode including a silicon element-containing active material or an Sn negative electrode containing an active material containing a tin element) can intercalate a larger amount of Li ions than a carbon negative electrode (for example, graphite or acetylene black). That is, the amount of Li ions intercalated per unit mass increases. As a result, the battery capacity (the energy density) can be increased. As a result, there is an advantage in that the battery driving duration can be extended.

Examples of the silicon element-containing active material include a silicon-containing alloy (for example, LaSi₂, VSi₂, La—Si, Gd—Si, or Ni—Si) including a silicon material such as Si or SiOx (0<x≤1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. It is noted that in addition, since SiOx itself can be used as a negative electrode active material (a metalloid oxide) and Si is produced along with the operation of an all-solid state secondary battery, SiOx can be used as a negative electrode active material (or a precursor material thereof) capable of being alloyed with lithium.

Examples of the negative electrode active material including the tin element include Sn, SnO, SnO₂, SnS, SnS₂, and the above-described active material including silicon element and tin element. In addition, a composite oxide with lithium oxide, for example, Li₂SnO₂ can also be used.

In the present invention, the above-described negative electrode active material can be used without any particular limitation. From the viewpoint of battery capacity, a preferred aspect as the negative electrode active material is a negative electrode active material that is capable of being alloyed with lithium. Among them, the silicon material or the silicon-containing alloy (the alloy containing a silicon element) described above is more preferable, and it is more preferable to include a negative electrode active material containing silicon (Si) or a silicon-containing alloy.

The chemical formulae of the compounds obtained by the above baking method can be calculated using an inductively coupled plasma (ICP) emission spectroscopy as a measuring method from the mass difference of powder before and after baking as a convenient method.

The shape of the negative electrode active material is not particularly limited but is preferably a particulate shape. The particle diameter of the negative electrode active material is preferably 0.1 to 60 μm. In order to provide a predetermined particle diameter, a typical crusher or classifier is used. For example, a mortar, a ball mill, a sand mill, a vibration ball mill, a satellite ball mill, a planetary ball mill, a swirling air flow jet mill, or a sieve is suitably used. During crushing, it is also possible to carry out wet-type crushing in which water or an organic solvent such as methanol is allowed to be present together as necessary. In order to provide the desired particle diameter, classification is preferably carried out. A classification method is not particularly limited, and a method using, for example, a sieve or an air classifier can be optionally used. Both the dry-type classification and the wet-type classification can be carried out. The particle diameter of the negative electrode active material particles can be measured in the same manner as the measurement of the particle diameter of the inorganic solid electrolyte.

One kind of the negative electrode active material may be used alone, or two or more kinds thereof may be used in combination.

In a case of forming a negative electrode active material layer, the mass (mg) (mass per unit area) of the negative electrode active material per unit area (cm²) in the negative electrode active material layer is not particularly limited. It can be appropriately determined according to the designed battery capacity and can be set to, for example, i to 100 mg/cm².

The content of the negative electrode active material in the active material layer is not particularly limited and is preferably 10% to 90% by mass, more preferably 20% to 85% by mass, still more preferably 30% to 80% by mass, and still more preferably 40% to 75% by mass.

### (Coating of Active Material)

The surfaces of the positive electrode active material and the negative electrode active material may be subjected to surface coating with another metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, the surface of the electrode containing the positive electrode active material or negative electrode active material may be subjected to a surface treatment with sulfur or phosphorus.

Further, the particle surface of the positive electrode active material or negative electrode active material may be subjected to a surface treatment with an actinic ray or an active gas (plasma or the like) before and after the surface coating.

### <Binder (D)>

The active material layer preferably contains the binder (D). As a result, it is possible to firmly adhere the solid particles to each other in the active material layer. In addition, it is also possible to firmly adhere the solid particles to the collector.

The binder (D) is not particularly limited as long as it is a binder that is usually used for an all-solid state secondary battery. Examples thereof include a sequential polymerization (polycondensation, polyaddition, or addition condensation) polymer such as polyurethane, polyurea, polyamide, polyimide, polyester, or polysiloxane, and a chain polymerization polymer such as a fluoropolymer (including a fluorine-containing polymer), a hydrocarbon polymer, a (meth)acrylic polymer, or a vinyl polymer, where a chain polymerization polymer is preferable, and a (meth)acrylic polymer or a vinyl polymer is more preferable. In addition, preferred examples of the binder (D) include the binder described in JP2015-088486A and the binder described in WO2017/131093A. Further, a particulate binder can also be used. Preferred examples of the particulate binder include the “binder particles A” and the “binder particles B” which are described in WO2019/230592A, the content of WO2019/230592A can be appropriately referred to, and the content thereof is incorporated as it is as a part of the description of the present specification.

The binder that is used in the present invention is preferably a binder (hereinafter, also referred to as a soluble type binder) that is dissolved in a dispersion medium contained in a composition for forming an active material layer, which will be described later. Examples of the soluble type binder include the “low adsorption binder” described in WO2021/039468A1, where a chain polymerization polymer, which contains a constitutional component having, as a substituent, a functional group selected from the group (a) of functional groups, is preferable, and a hydrocarbon-based polymer, a vinyl-based polymer, or a (meth)acrylic polymer, which contains a constitutional component having the functional group as a substituent, is more preferable. With regard to the “low adsorption binder”, the content described in WO2021/039468A1 can be appropriately referred to, and the content thereof is incorporated as it is as a part of the description of the present specification.

The content of the binder in the active material layer is not particularly limited, and it is, for example, preferably 0.1% to 5.0% by mass, more preferably 0.2% to 4.0% by mass, and still more preferably 0.3% to 2.0% by mass.

### <Conductive Auxiliary Agent>

It is preferable that the active material layer contains a conductive auxiliary agent. The conductive auxiliary agent is not particularly limited, and conductive auxiliary agents that are known as ordinary conductive auxiliary agents can be used. It may be, for example, graphite such as natural graphite and artificial graphite, carbon black such as acetylene black, Ketjen black, and furnace black, amorphous carbon such as needle cokes, carbon fibers such as a vapor-grown carbon fiber and a carbon nanotube, or a carbonaceous material such as graphene or fullerene, which are electron-conductive materials, and it may be also a metal powder or metal fiber of copper, nickel, or the like. A conductive polymer such as polyaniline, polypyrrole, polythiophene, polyacetylene, or a polyphenylene derivative may also be used.

In the present invention, in a case where the active material is used in combination with the conductive auxiliary agent, among the above-described conductive auxiliary agents, a conductive auxiliary agent that does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent that can function as the active material in the active material layer at the time of charging and discharging of the battery is classified as an active material but not as a conductive auxiliary agent. Whether or not the conductive auxiliary agent functions as the active material at the time of charging and discharging of a battery is not unambiguously determined but is determined by the combination with the active material.

In the present invention, in a case where the active material and the conductive auxiliary agent are jointly used, among the above-described conductive auxiliary agents, a conductive auxiliary agent that does not intercalate and deintercalate Li and does not function as an active material at the time of charging and discharging a battery is regarded as the conductive auxiliary agent. Therefore, among the conductive auxiliary agents, a conductive auxiliary agent that can function as the active material in the active material layer at the time of charging and discharging of the battery is classified as an active material but not as a conductive auxiliary agent. Whether or not the conductive auxiliary agent functions as the active material at the time of charging and discharging of a battery is not unambiguously determined but is determined by the combination with the active material.

One kind of conductive auxiliary agent may be contained, or two or more kinds thereof may be contained.

The shape of the conductive auxiliary agent is not particularly limited but is preferably a particulate shape.

In a case where the active material layer according to the embodiment of the present invention contains a conductive auxiliary agent, the content of the conductive auxiliary agent in the active material layer is preferably 0% to 10% by mass.

### <Additive>

As other components other than the above-described respective components, the active material layer according to the embodiment of the present invention can contain, as desired, additives such as an ionic liquid, a lithium salt (a supporting electrolyte), a thickener, an anti-foaming agent, a leveling agent, a dehydrating agent, and an antioxidant, at an appropriate content.

Generally, the lithium salt is preferably a lithium salt that is used for this kind of product and is not particularly limited. For example, lithium salts described in paragraphs [0082] to [0085] of JP2015-088486A are preferable. The ionic liquid is contained in order to further improve the ion conductivity, and the publicly known one in the related art can be used without particular limitation.

### [Manufacturing Method for Electrode Sheet]

A manufacturing method for an electrode sheet according to an embodiment of the present invention is not particularly limited. However, from the viewpoint that the polymer anchored portion and the electron conductive portion can be formed at the same time, preferred examples thereof include a method in which, first, a polymer composition containing the polymer (A) is used to form a polymer anchored portion on at least one surface of a collector, and then a film of a composition for forming an active material layer, where the composition contains an inorganic solid electrolyte and an active material, is formed on a surface of the collector in which the polymer anchored portion has been formed, where the surface is planned to be subjected to lamination (this method may be referred to as a preferred manufacturing method).

The polymer composition (preferably, an aqueous composition) that is used in the above-described suitable manufacturing method contains the polymer (A) that exhibits the above-described specific solubility (water, 25° C.), and it preferably contains a solvent and, as necessary, other components (additives and the like). The polymer (A), the additive, and the like, which are contained in the polymer composition, are as described above. The content of each component in the polymer composition is the same as the content in the polymer anchored portion in terms of the content in 100% by mass of the solid content (solid component) of the polymer composition.

In the present invention, unless otherwise specified, the solid content refers to a component that neither volatilizes nor evaporates and disappears in a case where the composition is dried at 170° C. for 6 hours in a nitrogen atmosphere at a pressure of 1 mmHg. Typically, it refers to components other than the solvent.

The solvent contained in the polymer composition is not particularly limited as long as it dissolves or disperses the polymer (A), and various publicly known solvents or water can be used. Among these, water or an aqueous solvent, which dissolves the polymer (A), is preferable. Examples of the aqueous solvent that disperses the polymer (A) include water, a (high-polarity) solvent that can be mixed with water, and a mixed solvent of the (high-polarity) solvent and water. Examples of the (high-polarity) solvent include an alcohol compound having 1 to 3 carbon atoms.

The content of the solvent in the polymer composition is not particularly limited; however, it is, for example, preferably 20% to 99% by mass, more preferably 30% to 95% by mass, and particularly preferably 40% to 90% by mass. From the viewpoint that the polymer anchored portion and the electron conductive portion can be formed at the same time, the polymer composition preferably has a low concentration of total solid contents, and it is, for example, preferably a dilute solution having a concentration of total solid contents of 20% by mass or less, and preferably a dilute solution having a concentration of total solid contents of 1% to 10% by mass.

In the above-described suitable manufacturing method, the above-described collector is prepared, and the polymer composition is solidified on the surface of the collector to form a polymer anchored portion. A method of solidifying the polymer composition is not particularly limited, and examples thereof include a method of applying the polymer composition onto a surface of a collector and drying the applied polymer composition (forming a film) and a method of applying, as the polymer composition, a monomer composition containing a monomer that forms a polymer onto a surface of a collector (carrying out polymerizing on the surface of the collector) and curing the applied monomer composition. Among the above, a film forming method that is simple and has good workability is preferable. The coating method in the film forming method is not particularly limited and can be appropriately selected. Examples thereof include coating (preferably wet-type coating), spray coating, spin coating, dip coating, slit coating, stripe coating, and bar coating.

In a case of applying the polymer composition, a mask member that masks the surface of the collector can also be used. As the mask member, it is possible to use, for example, a punching plate (perforated plate) having a shape corresponding to the arrangement or the like of the polymer anchored portion and the electron conductive portion, which is formed on the surface of the collector.

In a case of applying the polymer composition, the coating amount (the mass after drying, g/m²) of the polymer composition per unit area (m²) is not particularly limited; however, it is preferably 0.1 to 5.0 g/m² in a case of being a dilute solution having the above-described concentration of total solid contents, from the viewpoint that the polymer anchored portion and the electron conductive portion can be formed. The coating amount (g) of the polymer composition is more preferably 0.1 to 3.0 g/m². It is noted that coating speed of the polymer composition is not particularly limited and can be appropriately set under the conditions that the polymer (A) in the polymer composition is not applied and disposed on the entire surface of the collector.

A method and conditions for drying the polymer composition are not particularly limited and can be appropriately selected. For example, the drying temperature is preferably 30° C. or higher, more preferably 60° C. or higher, and still more preferably 80° C. or higher. The upper limit thereof is preferably 300° C. or lower, more preferably 250° C. or lower, still more preferably 200° C. or lower, and particularly preferably 130° C. or lower. The drying time is not particularly limited and can be appropriately set.

In the suitable manufacturing method for an electrode sheet according to the embodiment of the present invention, the above-described polymer composition, the film forming method, the presence or absence of a mask member, the coating amount, and the like can be combined for a film forming method suitable as a method of forming a polymer anchored portion on at least one surface of a collector. For example, a method of applying a polymer composition having a concentration of total solid contents of 20% by mass or less onto a surface planned to be subjected to lamination and drying the applied polymer composition, by setting a coating amount of the polymer composition per unit area (m²) to 0.1 to 5.0 g/m² is preferable. In this method, the concentration of total solid contents, the coating amount, the coating and drying conditions, and the presence or absence of a mask member can be appropriately selected from those described above. In addition, although the component contained in the polymer composition may be a monomer that forms a polymer, it is preferably a polymer.

In a manner as described above, the polymer anchored portion can be formed on a part of at least one surface of the collector. In particular, in the above-described suitable film forming method, the polymer composition can also be applied in a finely blurred state over the entire surface of the collector, and the polymer anchored portion and the electron conductive portion can also be allowed to be mixedly present (formed) randomly in an indeterminate shape in which they are finely scattered.

In the above-described suitable manufacturing method, next, an active material layer is formed on the surface (the surface planned to be subjected to lamination) of the collector on which the polymer anchored portion has been formed.

The composition for forming an active material layer (preferably, a hydrophobic composition) contains the inorganic solid electrolyte (B) and the active material (C), and it contains preferably a dispersion medium, preferably the binder (D), preferably a conductive auxiliary agent, and appropriately, various additives and the like. The inorganic solid electrolyte (B), the active material (C), the binder (D), the conductive auxiliary agent, the additive, and the like, which are contained in the composition for forming an active material layer, are as described above. It is noted that in addition to the above-described additives, the composition for forming an active material layer may contain a crosslinking agent (such a crosslinking agent that undergoes a crosslinking reaction by radical polymerization, condensation polymerization, or ring-opening polymerization) or a polymerization initiator (a polymerization initiator that generates an acid or a radical by heat or light).

The content of each component in the composition for forming an active material layer is the same as the above-described content in the active material layer in terms of the content in 100% by mass of the solid content (solid component) of the composition for forming an active material layer.

The dispersion medium contained in the composition for forming an active material layer is not particularly limited; however, it is preferably the polymer (A), that is, such one that does not dissolve the polymer anchored portion. Examples of such a dispersion medium include a dispersion medium having low polarity and exhibiting hydrophobicity, and more specifically, each organic solvent such as an ether compound, a ketone compound, an aromatic compound, an aliphatic compound, or an ester compound is preferable. Among the above, a ketone compound, an aromatic compound, an aliphatic compound, or an ester compound is preferable, and a ketone compound, an aromatic compound, or an ester compound is more preferable. With regard to the dispersion medium for each compound, the content described in WO2021/039468A1 can be appropriately referred to, and the content thereof is incorporated as it is as a part of the description of the present specification. Examples of the aromatic compound include benzene, toluene, and xylene, and suitable examples thereof include ethyl acetate, butyl acetate, propyl acetate, propyl butyrate, isopropyl butyrate, butyl butyrate, and isobutyl butyrate. In terms of hydrophobicity, the dispersion medium is preferably an organic solvent having 4 to 20 carbon atoms.

The dispersion medium preferably has a boiling point of 50° C. or higher and more preferably 70° C. or higher at normal pressure (1 atm). The upper limit thereof is preferably 250° C. or lower and more preferably 220° C. or lower.

One kind of the dispersion medium may be used alone, or two or more kinds thereof may be used in combination.

In the present invention, the content of the dispersion medium in the composition for forming an active material layer can be appropriately set without being particularly limited. For example, the content of the solvent in the composition for forming an active material layer is preferably 15% to 99% by mass, more preferably 20% to 70% by mass, and particularly preferably 25% to 60% by mass.

The composition for forming an active material layer can be prepared by mixing the above-described respective components and the solvent using an ordinary method. The mixing method is not particularly limited, and the components may be mixed collectively or may be mixed sequentially. The mixing environment is not particularly limited, and examples thereof include atmosphere such as atmospheric air, dry air (dew point: −20° C. or lower), or inert gas (for example, argon gas, helium gas, or nitrogen gas).

In the above-described preferred manufacturing method, a film of the composition for forming an active material layer is formed on a surface of the collector, where the surface is planned to be subjected to lamination. It is preferable that in the film formation, the composition for forming an active material layer is applied and dried. As a result, an active material layer is formed on a surface planned to be subjected to lamination without dissolving the polymer anchored portion that has undergone anchoring, whereby it is possible to produce the electrode sheet according to the embodiment of the present invention.

A coating method for the composition for forming an active material layer is not particularly limited; however, it is the same as the method of applying the polymer composition. It is noted that coating conditions are not particularly limited and are appropriately set. In addition, the drying method (conditions) for drying the composition for forming an active material layer is not particularly limited, and the temperature is, for example, preferably 30° C. or higher, more preferably 60° C. or higher, and still more preferably 80° C. or higher. The upper limit thereof is preferably 300° C. or lower, more preferably 250° C. or lower, and still more preferably 200° C. or lower.

In the above-described suitable manufacturing method, it is also possible to pressurize the active material layer that has been obtained in this way. The pressurizing condition and the like will be described later in the section of the manufacturing method for an all-solid state secondary battery. The pressurizing force can be set to be lower than the pressurizing force to be applied to the all-solid state secondary battery and can be set to be, for example, 2 to 100 MPa.

In the above-described suitable manufacturing method, the active material layer is formed by a method of forming a film; however, in the present invention, the method of forming the active material layer is not limited to the above-described film forming method, and it is also possible to apply, for example, a method of laminating (carrying out pressurization bonding of) an active material layer which is separately produced, on a surface (a surface planned to be subjected to lamination) of a collector.

### [All-Solid State Secondary Battery]

The all-solid state secondary battery including, as an electrode, the electrode sheet according to the embodiment of the present invention has a positive electrode (a positive electrode collector and a positive electrode active material layer), a negative electrode (a negative electrode active material layer and a negative electrode collector) that faces the positive electrode, and a solid electrolyte layer that is disposed between the positive electrode (positive electrode active material layer) and the negative electrode (negative electrode active material layer). In the present invention, at least one or preferably both of the positive electrode and the negative electrode are composed of the electrode sheet according to the embodiment of the present invention. The collector and the active material layer are the same as those in the electrode sheet according to the embodiment of the present invention. It is noted that in a case where one of the positive electrode or the negative electrode is not formed of the electrode sheet according to the embodiment of the present invention, this electrode can be formed of a well-publicly known solid electrolyte composition including an active material.

The solid electrolyte layer is formed of, for example, a typical solid electrolyte composition including a solid electrolyte.

The thickness of each of the negative electrode active material layer, the solid electrolyte layer, and the positive electrode active material layer is not particularly limited. In case of taking a dimension of a general all-solid state secondary battery into account, the thickness of each of the layers is preferably 10 to 1,000 μm and more preferably 20 μm or more and less than 500 μm.

### [Housing]

Depending on the use application, the all-solid state secondary battery according to the embodiment of the present invention may be used as the all-solid state secondary battery having the above-described structure as it is but is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

Hereinafter, an all-solid state secondary battery according to a preferred embodiment of the present invention will be described with reference to FIG. 2; however, the present invention is not limited thereto.

FIG. 2 is a cross-sectional view schematically illustrating the all-solid state secondary battery (lithium ion secondary battery) according to the preferred embodiment of the present invention. An all-solid state secondary battery 10 according to the present embodiment is a secondary battery in which both the positive electrode and the negative electrode are formed of the electrode sheet according to the embodiment of the present invention, and the polymer anchored portion is not shown in FIG. 2. In a case of being seen from the negative electrode side, the all-solid state secondary battery 10 includes a negative electrode collector 1, a negative electrode active material layer 2, a solid electrolyte layer 3, a positive electrode active material layer 4, and a positive electrode collector 5 in this order. The respective layers are in contact with each other, and thus structures thereof are adjacent. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated in the negative electrode return to the positive electrode side, and electrons are supplied to an operation portion 6. In an example illustrated in the drawing, an electric bulb is employed as a model at the operation portion 6 and is lit by discharging.

In the present invention, a functional layer, a functional member, or the like may be appropriately interposed or disposed between each layer of the negative electrode collector, the negative electrode active material layer, the solid electrolyte layer, the positive electrode active material layer, and the positive electrode collector on the outside thereof. In addition, each layer may be composed of a single layer or multiple layers.

The all-solid state secondary battery according to the embodiment of the present invention includes an electrode consisting of the electrode sheet according to the embodiment of the present invention, and thus the collector is firmly adhered to the active material layer as described above, and the peeling of the active material layer from the collector can be prevented, whereby high battery performance (ion conductivity and cycle characteristics) is exhibited. The all-solid state secondary battery according to the embodiment of the present invention has a small capacity deterioration even in a case of being driven for a long period of time and exhibits high ion conductivity, and thus it is possible to extract a large current.

—Use Application of all-Solid State Secondary Battery—

The all-solid state secondary battery according to the embodiment of the present invention exhibits the above-described excellent characteristics and can be applied to various use applications. Application aspects are not particularly limited, and, in the case of being mounted in electronic apparatuses, examples of the electronic apparatuses include notebook computers, pen-based input personal computers, mobile personal computers, e-book players, mobile phones, cordless phone handsets, pagers, handy terminals, portable faxes, mobile copiers, portable printers, headphone stereos, video movies, liquid crystal televisions, handy cleaners, portable CDs, mini discs, electric shavers, transceivers, electronic notebooks, calculators, memory cards, portable tape recorders, radios, and backup power supplies. Additionally, examples of the consumer usage thereof include an automobile, an electric vehicle, a motor, a lighting instrument, a toy, a game device, a road conditioner, a watch, a strobe, a camera, and a medical device (a pacemaker, a hearing aid, a shoulder massage device, and the like). Further, the all-solid state secondary battery can be used for a variety of military usages and universe usages. In addition, the all-solid state secondary battery can also be combined with a solar battery.

[Manufacturing Method for all-Solid State Secondary Battery]

The all-solid state secondary battery according to the embodiment of the present invention is not particularly limited as long as it is manufactured through (by undergoing) a method of carrying out manufacturing using the electrode sheet according to the embodiment of the present invention, that is, the manufacturing method for an electrode sheet according to the embodiment of the present invention, and it can be manufactured by a publicly known method using the electrode sheet according to the embodiment of the present invention.

Hereinafter, a manufacturing method for an all-solid state secondary battery will be described below in detail.

A manufacturing method for an all-solid state secondary battery according to an embodiment of the present invention is a method of carrying out manufacturing through the manufacturing method for an electrode sheet according to an embodiment of the present invention. For example, an all-solid state secondary battery can be manufactured by manufacturing the electrode according to the embodiment of the present invention and forming a solid electrolyte layer using the electrode. Specifically, the solid electrolyte layer may be formed on the electrode or may be disposed or transferred to the electrode. By laminating another electrode on the solid electrolyte layer formed as described above, an all-solid state secondary battery is formed. As long as the electrode sheet according to the embodiment of the present invention is used as at least one electrode, a typical electrode (a laminate including a collector and an active material layer) may be prepared and used as another electrode. Preferred examples of the manufacturing method include a method of preparing the electrode sheet according to the embodiment of the present invention as a positive electrode and a negative electrode and disposing a solid electrolyte layer between these electrodes.

A film of the solid electrolyte layer can be formed, for example, by preparing a solid electrolyte composition and applying and drying the solid electrolyte composition. The solid electrolyte composition is a composition containing a solid electrolyte, preferably a dispersion medium, preferably a binder, and appropriately the above-described additives, and it is preferably a slurry. The components contained in the solid electrolyte composition are as described above. As the dispersion medium, various dispersion media that are generally used for forming a solid electrolyte layer, for example, the above-described dispersion medium that is used for a composition for forming an active material layer can be used without particular limitation.

The solid electrolyte composition is not particularly limited; however, it is preferably a non-aqueous composition. Specifically, a water content (also referred to as a moisture content) thereof is more preferably 500 ppm or less, still more preferably 200 ppm or less, particularly preferably 100 ppm or less, and most preferably 50 ppm or less. The moisture content refers to the amount of water (the mass proportion thereof to the solid electrolyte composition) in the solid electrolyte composition and specifically is determined as a value measured by Karl Fischer titration after filtering the solid electrolyte composition through a membrane filter having a pore size of 0.02 μm.

### <Formation of Solid Electrolyte Layer (Film Formation)>

A coating method for the solid electrolyte composition is not particularly limited, and the same method as the above-described coating method for the polymer composition can be applied. It is noted that coating conditions are not particularly limited and are appropriately set. In addition, a drying method (conditions) for the solid electrolyte composition is not particularly limited either, and the above-described drying method (conditions) for a composition for forming an active material layer can be applied.

It is preferable that the solid electrolyte composition which has been subjected to film formation or the manufactured all-solid state secondary battery is pressurized. Examples of the pressurizing methods include a method using a hydraulic cylinder press machine. The pressurizing force is not particularly limited; however, it is, in general, preferably in a range of 50 to 1,500 MPa.

The above-described pressurization and the heating of the solid electrolyte composition can also be carried out at the same time. The heating temperature is not particularly limited; however, it is generally in a range of 30° C. to 300° C. The press can also be applied at a temperature higher than the glass transition temperature of the inorganic solid electrolyte. On the other hand, in a case where the inorganic solid electrolyte and the binder are present together, the pressing can also be carried out at a temperature higher than the glass transition temperature of a resin that forms the binder. The pressurization may be carried out in a state where the dispersion medium has been dried in advance or in a state where the dispersion medium remains. The pressurization time may be a short time (for example, within several hours) under the application of a high pressure or a long time (one day or longer) under the application of an intermediate pressure. In a case where the all-solid state secondary battery is pressurized, a restraining tool (a screw fastening pressure or the like) can also be used in order to continuously apply an intermediate pressure.

The pressing pressure may be uniform or variable with respect to a portion under pressure. In this case, the pressing pressure may be changed according to the area or the film thickness of the portion under pressure. In addition, the same portion can be pressurized stepwise at different pressures. A pressing surface may be flat or roughened.

The atmosphere in each of steps of coating, drying, and pressurization (under heating) is not particularly limited and may be any atmosphere such as atmospheric air, dry air (the dew point: −20° C. or lower), or inert gas (for example, an argon gas, a helium gas, or a nitrogen gas).

### <Initialization>

It is preferable that the secondary battery manufactured as described above is subjected to initialization after the manufacturing or before the use. The initialization is not particularly limited, and it is possible to initialize the all-solid state secondary battery by, for example, carrying out initial charging and discharging in a state where the pressing pressure is increased and then releasing the pressure until it reaches a general working pressure of the secondary battery.

In the electrode sheet according to the embodiment of the present invention, the collector and the electrode active material layer are firmly bound to each other. Therefore, the occurrence of peeling between the collector and the active material layer can be suppressed, for example, even in a case where the electrode according to the embodiment of the present invention is line manufactured in a long shape (even in a case where the electrode is wound during transportation) or in a case where the electrode is manufactured by a roll-to-roll method. In a case where such an electrode sheet is used, it is possible to manufacture an all-solid state secondary battery that exhibits excellent battery performance, with high productivity and a high yield (reproducibility).

### EXAMPLES

Hereinafter, the present invention will be described in more detail based on Examples; however, the present invention is not limited thereto be interpreted. “Parts” and “%” that represent compositions in the following Examples are in terms of mass unless particularly otherwise described. In the present invention, “room temperature” means 25° C.

### 1. Polymer Synthesis

Polymers S-1 to S-4 and T-1 shown by the following chemical formulae and in Table 1 below were synthesized as follows.

### [Synthesis Example S-1] Synthesis of Polymer S-1 and Preparation of Polymer Solution S-1

To a 100 mL volumetric flask, 17.3 g of PHOSMER M, in which the phosphate group was neutralized with sodium hydroxide, 18.0 g of polyethylene glycol monomethyl ether methacrylate (molecular weight: 500, manufactured by Sigma-Aldrich Co., LLC), 0.72 g of a dimethylaminoethyl methacrylate quaternary nitrogen compound M-1, and 0.72 g of a polymerization initiator V-50 (product name, manufactured by FUJIFILM Wako Pure Chemical Corporation) were added and dissolved in 72.0 g of butyl butyrate to prepare a monomer solution.

To a 300 mL three-neck flask, 72.0 g of butyl butyrate was added and stirred at 70° C., and then the above monomer solution was added dropwise thereto over 2 hours. After completion of the dropwise addition, the temperature was raised to 80° C., and stirring was carried out for 2 hours. The obtained polymerization solution was poured into 480 g of toluene, stirred for 10 minutes, and allowed to stand for 10 minutes. The precipitate obtained after removing the supernatant was dissolved in 80 g of water and heated at 30 hPa and 60° C. for 1 hour to distill off toluene.

In this way, a polymer S-1 ((meth)acrylic polymer) was synthesized to obtain a solution S-1 of the polymer S-1 (concentration: 32% by mass).

### [Synthesis Example S-2] Synthesis of Polymer S-2 and Preparation of Polymer Solution S-2

To a 100 mL volumetric flask, 18.0 g of 4-vinylbenzoic acid (VbA), 10.3 g of a vinylpyridine hydrochloride M-2, and 0.72 g of a polymerization initiator V-601 (product name, manufactured by FUJIFILM Wako Pure Chemical Corporation) were added and dissolved in 72.0 g of ethanol to prepare a monomer solution.

To a 300 mL three-neck flask, 72.0 g of butyl butyrate was added and stirred at 80° C., and then the above monomer solution was added dropwise thereto over 2 hours. After the completion of the dropwise addition, the solution was heated to 90° C. and stirred for 2 hours. 50.0 g of methyl iodide (manufactured by FUJIFILM Wako Pure Chemical Corporation) was added to the obtained polymerization solution in a state of being stirred at 40° C., and the resultant mixture was stirred for 5 hours. The obtained reaction solution was poured into 480 g of toluene, stirred for 10 minutes, and allowed to stand for 10 minutes. The precipitate obtained after removing the supernatant was redissolved in 100 g of ethanol and poured again into 480 g of toluene. The precipitate obtained after removing the supernatant was dissolved in 80 g of water and heated at 30 hPa and 60° C. for 1 hour to distill off toluene and ethanol.

In this way, a polymer S-2 was synthesized to obtain a solution S-2 (concentration: 28% by mass) of the polymer S-2.

### [Synthesis Example S-3] Synthesis of Polymer S-3 and Preparation of Polymer Solution S-3

A solution S-3 of a polymer S-3 (concentration: 24% by mass) was obtained in the same manner as in Synthesis Example S-1, except that in Synthesis Example S-1, a compound from which each constitutional component is derived was adjusted so that the polymer S-3 had the composition (the kind and the content of the constitutional component) shown in the following chemical formula and Table 1.

### [Synthesis Example S-4] Synthesis of Polymer S-4 and Preparation of Polymer Solution S-4

A solution S-4 of a polymer S-4 (concentration: 30% by mass) was obtained in the same manner as in Synthesis Example S-1, except that in Synthesis Example S-1, a compound from which each constitutional component is derived was adjusted so that the polymer S-4 had the composition (the kind and the content of the constitutional component) shown in the following chemical formula and Table 1.

### [Synthesis Example T-1] Synthesis of Polymer T-1 and Preparation of Polymer Solution

T-1 To a 100 mL volumetric flask, 18.0 g of styrene (manufactured by Tokyo Chemical Industry Co., Ltd.), 18.0 g of dodecyl acrylate (manufactured by Tokyo Chemical Industry Co., Ltd.), and 0.36 g of a polymerization initiator V-601 (product name, manufactured by FUJIFILM Wako Pure Chemical Corporation) were added and dissolved in 72.0 g of butyl butyrate to prepare a monomer solution.

To a 300 mL three-neck flask, 72.0 g of butyl butyrate was added and stirred at 80° C., and then the above monomer solution was added dropwise thereto over 2 hours. After the completion of the dropwise addition, the solution was heated to 90° C. and stirred for 2 hours. The obtained polymerization solution was poured into 480 g of methanol, stirred for 10 minutes, and allowed to stand for 10 minutes. The precipitate obtained after removing the supernatant was dissolved in 80 g of butyl butyrate and heated at 30 hPa and 60° C. for 1 hour to distill off methanol.

In this way, a polymer T-1 ((meth)acrylic polymer) was synthesized to obtain a solution T-1 of the polymer T-1 (concentration: 22% by mass).

A polymer D-1 shown by the following chemical formula was synthesized as follows to prepare a binder solution D-1.

### [Synthesis Example D-1] Synthesis of Polymer D-1 and Preparation of Binder Solution D-1

To a 100 mL volumetric flask, 1.8 g of 2-hydroxyethyl acrylate (manufactured by Tokyo Chemical Industry Co., Ltd.), 1.8 g of acrylic acid (manufactured by FUJIFILM Wako Pure Chemical Corporation), 32.4 g of dodecyl methacrylate (manufactured by FUJIFILM Wako Pure Chemical Corporation), and 0.36 g of a polymerization initiator V-601 (product name, manufactured by FUJIFILM Wako Pure Chemical Corporation) were added and dissolved in 72.0 g of butyl butyrate to prepare a monomer solution.

To a 300 mL three-neck flask, 72.0 g of butyl butyrate was added and stirred at 80° C., and then the above monomer solution was added dropwise thereto over 2 hours. After the completion of the dropwise addition, the solution was heated to 90° C. and stirred for 2 hours. The obtained polymerization solution was poured into 480 g of methanol, stirred for 10 minutes, and allowed to stand for 10 minutes. The precipitate obtained after removing the supernatant was dissolved in 80 g of butyl butyrate and heated at 30 hPa and 60° C. for 1 hour to distill off methanol.

In this way, a polymer D-1 ((meth)acrylic polymer) was synthesized to obtain a binder solution D-1 (concentration: 26% by mass) containing the polymer D-1.

Each of the polymers synthesized is shown below. The numerical value at the bottom right of each constitutional component indicates the content (% by mass). In addition, the composition and the mass average molecular weight (in terms of the measured value according to the method described above) of each polymer are shown in Table 1.

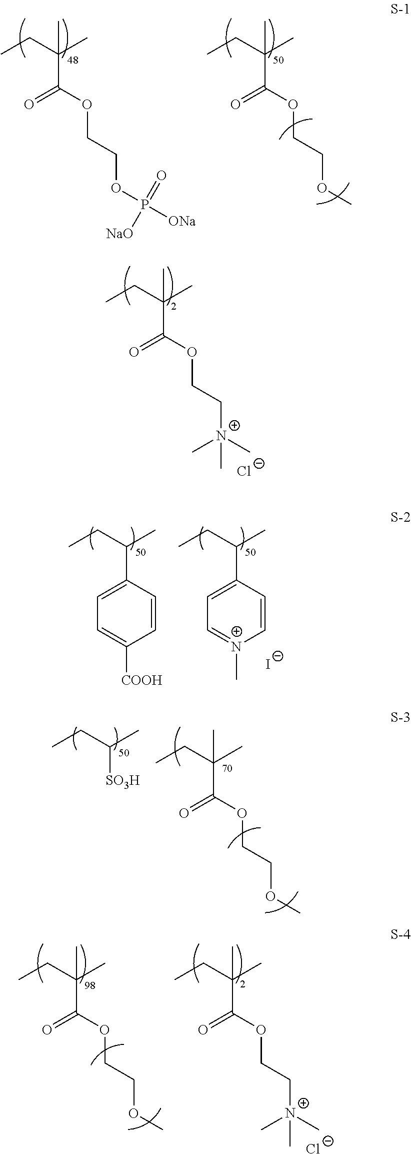

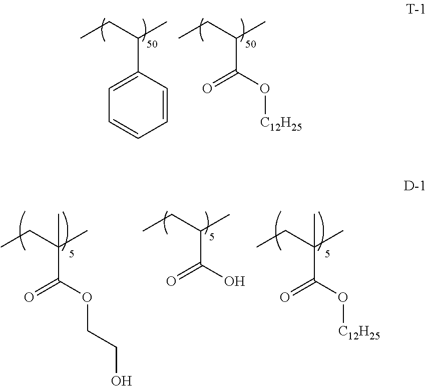

TABLE 1

| | | | | | | | Mass |
|---|---|---|---|---|---|---|---|
| | Constitutional component M1 | | Constitutional component M2 | | Constitutional component M3 | | average |
| | | Content | | Content | | Content | molecular |
| No. | | (% by mass) | | (% by mass) | | (% by mass) | weight |
| S-1 | PHOSMER M | 48 | PEGMEM 500 | 50 | M-1 | 2 | 85,000 |
| S-2 | VbA | 50 | — | — | M-2 | 50 | 99,000 |
| S-3 | VsA | 30 | PEGMEM 300 | 70 | — | — | 45,000 |
| S-4 | — | — | PEGMEM 500 | 98 | M-1 | 2 | 110,000 |
| T-1 | St | 50 | LA | 50 | — | — | 76,000 |

### Abbreviations in Table

### —Constitutional Component M1—

A constitutional component M1 is a constitutional component having an acidic functional group or a salt thereof. It is noted that although a constitutional component St of the polymer T-1 does not correspond to the constitutional component M1, it is shown in this section column for convenience.
PHOSMER M: A disodium salt of 2-(methacryloyloxy)ethyl phosphate (manufactured by UNICHEMICALS CO., LTD.)
VbA: 4-vinylbenzoic acid (manufactured by Tokyo Chemical Industry Co., Ltd.)
VsA: vinylsulfonic acid (manufactured by Tokyo Chemical Industry Co., Ltd.)
St: Styrene (manufactured by FUJIFILM Wako Pure Chemical Corporation)

### —Constitutional Component M2—

A constitutional component M2 is another constitutional component (Z).
PEGMEM 500: Poly(ethylene glycol) methyl ether methacrylate (number average molecular weight: 500, manufactured by Sigma-Aldrich Co., LLC.)
PEGMEM 300: Poly(ethylene glycol) methyl ether methacrylate (number average molecular weight: 300, manufactured by Sigma-Aldrich Co., LLC.)
LA: Lauryl acrylate (manufactured by Tokyo Chemical Industry Co., Ltd.)
   —Constitutional component M3—

A constitutional component M3 is a constitutional component having a salt of a basic functional group.
M-1: A dimethylaminoethyl methacrylate quaternary nitrogen compound (manufactured by Kyoeisha Chemical Co., Ltd.)
M-2: N-methylpyridinium iodide

### 2. Synthesis of Sulfide-Based Inorganic Solid Electrolyte

### Synthesis Example A

A sulfide-based inorganic solid electrolyte was synthesized with reference to a non-patent document of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box in an argon atmosphere (dew point: −70° C.), lithium sulfide (Li₂S, manufactured by Sigma-Aldrich Co., LLC Co., LLC Co., LLC, purity: >99.98%) (2.42 g) and diphosphorus pentasulfide (P₂S₅, manufactured by Sigma-Aldrich Co., LLC Co., LLC Co., LLC, purity: >99%) (3.90 g) each were weighed, put into an agate mortar, and mixed using an agate pestle for five minutes. The mixing ratio between Li₂S and P₂S₅(Li₂S:P₂S₅) was set to 75:25 in terms of molar ratio.

Next, 66 g of zirconia beads having a diameter of 5 mm were put into a 45 mL container made of zirconia (manufactured by FRITSCH), the entire amount of the mixture of the above lithium sulfide and the diphosphorus pentasulfide was put thereinto, and the container was completely sealed in an argon atmosphere. The container was set in a planetary ball mill P-7 (product name, manufactured by FRITSCH), mechanical milling was carried out at a temperature of 25° C. and a rotation speed of 510 rpm for 20 hours, thereby obtaining a yellow powder (6.20 g) of a sulfide-based inorganic solid electrolyte (Li—P—S-based glass, hereinafter, may be denoted as LPS). The particle diameter of the Li—P—S-based glass was 15 μm.

### 3. Production of Positive Electrode Sheets PK-1 to PK-10 and PKc21 to PKc23

### <Production of Positive Electrode Sheet PK-1>

### (Preparation of Polymer Composition PC-1)

3 g of polyethylene glycol 1000 (PEG 1000, manufactured by FUJIFILM Wako Pure Chemical Corporation) was added to 57 g of ethanol and dissolved at room temperature for 1 hour using a planetary mixer to prepare a polymer composition (solution) PC-1 having a concentration of solid contents of 5% by mass.

### (Production of Positive Electrode Collector PP-1)

Next, the polymer composition PC-1 Was applied onto an aluminum foil (positive electrode collector) having a thickness of 20 μm in a dry room set at a dew point of −60° C. with a Baker type applicator (product name: SA-201, manufactured by Tester Sangyo Co., Ltd.) so that the coating amount after drying was 1.1 g/m², and then drying was carried out on a hot plate at 100° C. for 1 hour. In this way, a positive electrode collector PP-1 having a polymer anchored portion having a thickness of 100 nm in a part of the surface planned to be subjected to lamination was prepared.

### (Preparation of Composition PKC-1 for Forming Positive Electrode Active Material Layer)

180 zirconia beads having a diameter of 5 mm were put into a 45 mL zirconia container (manufactured by Fritsch Japan Co., Ltd.), and 2.8 g of the above-described synthesized LPS, 0.1 g of (in terms of solid contents) of the binder solution D-1, and 12.3 g of toluene as a dispersion medium were put thereinto. The container was set in a planetary ball mill P-7 (product name, manufactured by FRITSCH), and mixing was carried out for 2 hours at a temperature of 25° C. and a rotation speed of 300 rpm. Thereafter, 7.0 g of NMC (LiNi_{1/3}Co_{1/3}Mn_{1/3}O₂(manufactured by Sigma-Aldrich Co., LLC)) as an active material and 0.2 g of acetylene black as a conductive auxiliary agent (manufactured by Denka Company Limited) were put into the container. Likewise, the container was set in a planetary ball mill P-7, and mixing was continued for 10 minutes at 25° C. and a rotation speed of 100 rpm to prepare a composition PKC-1 for forming a positive electrode active material layer.

In the composition PKC-1 for forming a positive electrode active material layer, the binder D-1 was dissolved.

### (Production of Positive Electrode Sheet PK-1)

The prepared composition PKC-1 for forming a positive electrode active material layer was applied onto a surface of the positive electrode collector PP-1, the surface being planned to be subjected to lamination, with a Baker type applicator (product name: SA-201, manufactured by Tester Sangyo Co., Ltd.) so that the mass per unit area was 30 mg/cm². Heating was carried out at 80° C. for 1 hour, and then drying was carried out at 110° C. for 1 hour. In this way, a positive electrode active material layer (thickness: 120 μm) was formed on the surface planned to be subjected to lamination, thereby producing a positive electrode sheet PK-1 having a polymer anchored portion at a part of the interface between the positive electrode collector and the positive electrode active material layer.

### <Production of Positive Electrode Sheets PK-2 to PK-6>

Each of positive electrode sheets PK-2 to PK-6 having a polymer anchored portion at a part of the interface between the positive electrode collector and the positive electrode active material layer was produced in the same manner as in the production of the positive electrode sheet PK-1, except that in the preparation of the polymer composition PC-1, each polymer or polymer solution (the blending amount of the polymer solution was set as an amount in terms of solid contents) shown in the column of “Polymer (A)” in the column of “Polymer anchored portion” in Table 2 was used instead of polyethylene glycol 1000, to prepare each of polymer compositions PC-2 to PC-6.

### <Production of Positive Electrode Sheet PK-7>

A positive electrode sheet PK-7 having a polymer anchored portion at a part of the interface between the positive electrode collector and the positive electrode active material layer was produced in the same manner as in the production of the positive electrode sheet PK-1, except that in the preparation of the polymer composition PC-1, the polymer solution S-1 (the blending amount thereof was set as an amount in terms of solid contents) was used instead of polyethylene glycol 1000 to prepare a polymer composition PC-7, and in the preparation of the composition PKC-1 for forming a positive electrode active material layer, Li_{0.33}La_{0.55}TiO₃ (LLT, manufactured by Toshima Manufacturing Co., Ltd.) was used instead of LPS to prepare a composition PKC-7 for forming a positive electrode active material layer.

### <Production of Positive Electrode Sheet PK-8>

A positive electrode sheet PK-8 having a polymer anchored portion at a part of the interface between the positive electrode collector and the positive electrode active material layer was produced in the same manner as in the production of the positive electrode sheet PK-1, except that in the production of the positive electrode sheet PK-1, a polymer composition PC-8 prepared as follows was used.

### (Preparation of Polymer Composition PC-8)

A polymer composition PC-8 was prepared in the same manner as in the preparation of the polymer composition PC-1, except that in the preparation of the polymer composition PC-1, a mixture of the polymers S-1 and the polymer T-1 (the blending amount thereof was set as an amount in terms of solid contents) having a mass ratio of 50:50 in terms of solid content was used instead of the polyethylene glycol 1000.

### <Production of Positive Electrode Sheets PK-9 and PK-10>

Each of positive electrode sheets PK-9 and PK-10 having a polymer anchored portion at a part of the interface between the positive electrode collector and the positive electrode active material layer was produced in the same manner as in the production of the positive electrode sheet PK-1, except that in the production of the polymer composition PK-1, the polymer solution S-1 (the blending amount thereof was set as an amount in terms of solid contents) was used instead of polyethylene glycol 1000 to prepare polymer compositions PC-9 and PC-10, and each polymer compositions was applied so that the coating amount after drying was 1.4 g/m² or 0.5 g/m² to prepare each of positive electrode collectors PP-9 and PP-10.

It is noted that the thickness of the polymer anchored portion was 130 nm in the positive electrode collector PP-9 and 40 nm in the positive electrode collector PP-10.

### <Production of Positive Electrode Sheets PKc21 and PKc22>

Each of positive electrode sheets PKc21 and PKc22 was produced in the same manner as in the production of the positive electrode sheet PK-1, except that in the preparation of the polymer composition PC-1, the polymer solution T-1 (the blending amount of the polymer solution was set as an amount in terms of solid contents) or styrene-butadiene rubber (SBR) shown in the column of “Polymer (A)” in the column of “Polymer anchored portion” in Table 2 was used instead of polyethylene glycol 1000, and butyl butyrate was used instead of the above-described solvent to prepare each of polymer compositions PCc-1 and PCc-2.

### <Production of Positive Electrode Sheet PKc23>

A positive electrode sheet PKc23 was produced in the same manner as in the production of the positive electrode sheet PK-1, except that in the preparation of the polymer composition PC-1, a mixture of the polymer solutions S-1 and the polymer T-1 (the blending amount thereof was set as an amount in terms of solid contents) having a mass ratio of 45:55 in terms of solid content was used instead of the polyethylene glycol 1000, and butyl butyrate was used instead of the above-described solvent to prepare a polymer composition PCc-3.

### 4. Production of Negative Electrode Sheets NK-1 to NK-8 and NKc21 to NKc23

### <Production of Negative Electrode Sheet NK-1>

### (Production of Negative Electrode Collector AP-1)

A negative electrode collector AP-1 in which a polymer anchored portion (thickness: 100 nm) was provided on a part of a surface planned to be subjected to lamination was produced in the same manner as in the production of the positive electrode collector PP-1, except that the aluminum foil was changed to a copper foil (negative electrode collector) in the production of the positive electrode collector PP-1.

### (Preparation of Composition NKC-1 for Forming Negative Electrode Active Material Layer)

180 zirconia beads having a diameter of 5 mm were put into a 45 mL zirconia container (manufactured by Fritsch Japan Co., Ltd.), and 2.8 g of the above-described synthesized LPS, 0.1 g of (in terms of solid contents) of the binder solution D-1, and 12.3 g of toluene as a dispersion medium were put thereinto. The container was set in the planetary ball mill P-7, and mixing was carried out at a temperature of 25° C. and a rotation speed of 300 rpm for 2 hours. Then, 7.0 g of graphite (product name, CGB20, manufactured by Nippon Graphite Industries, Co., Ltd.) as an active material and 0.2 g of carbon nanotube: VGCF-H (product name, manufactured by SHOWA DENKO K.K.) as a conductive auxiliary agent were put into a container. Likewise, the container was set in the planetary ball mill P-7, and mixing was continued for 15 minutes at 25° C. and a rotation speed of 200 rpm to prepare a composition NKC-1 for forming a negative electrode active material layer.

In the composition NKC-1 for forming a positive electrode active material layer, the binder D-1 was dissolved.

### (Production of Negative Electrode Sheet NK-1)

The prepared composition NKC-1 for forming a negative electrode active material layer was applied onto a surface of the negative electrode collector AP-1, the surface being planned to be subjected to lamination, with a Baker type applicator (product name: SA-201) so that the mass per unit area was 15 mg/cm². Heating was carried out at 80° C. for 1 hour, and then drying was carried out at 110° C. for 1 hour. In this way, a negative electrode active material layer (thickness: 110 μm) was formed on the surface planned to be subjected to lamination, thereby producing a negative electrode sheet NK-1 having a polymer anchored portion at a part of the interface between the negative electrode collector and the negative electrode active material layer.

### <Production of Negative Electrode Sheets NK-2 to NK-6>

Each of negative electrode sheets NK-2 to NK-6 having a polymer anchored portion at a part of the interface between the negative electrode collector and the negative electrode active material layer was produced in the same manner as in the production of the negative electrode sheet NK-1, except that the polymer compositions PC-2 to PC-6 were used instead of the polymer composition PC-1 in the production of the negative electrode collector AP-1.

### <Production of Negative Electrode Sheet NK-7>

A negative electrode sheet NK-7 having a polymer anchored portion at a part of the interface between the negative electrode collector and the negative electrode active material layer was produced in the same manner as in the production of the negative electrode sheet NK-1, except that the polymer composition PC-7 was used instead of the polymer composition PC-1 in the production of the negative electrode collector AP-1, and in the preparation of the composition NKC-1 for forming a negative electrode active material layer, Li_{0.33}La_{0.55}TiO₃ (LLT, manufactured by Toshima Manufacturing Co., Ltd.) was used instead of LPS to prepare a composition PKC-7 for forming a negative active material layer.

### <Production of Negative Electrode Sheet NK-8>

A negative electrode sheet NK-8 having a polymer anchored portion at a part of the interface between the negative electrode collector and the negative electrode active material layer was produced in the same manner as in the production of the negative electrode sheet NK-1, except that the polymer composition PC-8 prepared in the production of the positive electrode sheet PK-8 was used in the production of the negative electrode sheet NK-1.

### <Production of Negative Electrode Sheets NKc21 and NKc22>

Each of negative electrode sheets NKc21 and NKc22 was produced in the same manner as in the production of the negative electrode sheet NK-1, except that the polymer composition PCc-1 or PCc-2 was used instead of the polymer composition PC-1 in the production of the negative electrode collector AP-1.

### <Production of Negative Electrode Sheet NKc23>

A negative electrode sheet NKc23 was produced in the same manner as in the production of the negative electrode sheet NK-1, except that the polymer composition PCc-3 was used instead of the polymer composition PC-1 in the production of the negative electrode collector AP-1.

The solubility (water, 25° C.) of each of the polymers (A) used, and the following characteristics or physical properties of each of the collectors produced, which had a polymer anchored portion, were measured or calculated.

### <Measurement of Solubility (Water, 25° C.)>

The solubility in water at 25° C. (g/100 g) was measured for each of the synthesized polymers S-1 to S-4 and T-1 and commercially available PEG 1000, polyvinyl alcohol, and SBR.

Specifically, 1 g of each polymer was added to water while stirring 100 g of water (adjusted to a water temperature of 25° C.), and a value (adding amount) immediately before the undissolved substance appeared was defined as the solubility (water, 25° C.). The obtained solubility (water, 25° C.) was classified according to the following standards and are shown in Table 2. It is noted that in the mixture of the polymer S-1 and the polymer T-1, only the results of the polymer S-1 having a higher solubility in water are shown in Table 2.

### —Standards for Solubility—

A: 10 g/100 g or more
B: 5 g/100 g or more and less than 10 g/100 g
C: 1 g/100 g or more and less than 5 g/100 g
D: Even 1 g of the polymer was not dissolved, and the undissolved substance could be confirmed.

### <Measurement of Surface Electrical Resistance Value>

Each of the prepared polymer compositions was applied onto a Teflon (registered trademark) sheet using a Baker type applicator (manufactured by Paltek Corporation), allowed to stand in an air sending dryer (manufactured by Yamato Scientific Co., Ltd.), and dried at 100° C. for 8 hours, and then a polymer layer having a thickness of 50 μm or more was obtained by being gently peeled off from the Teflon (registered trademark) sheet. A surface electrical resistance of the obtained polymer layer was measured according to JIS C 2151. The obtained surface electrical resistance value (unit: Q/Q) was defined as the surface electrical resistance value of the polymer anchored portion. As a result, all of the polymer anchored portions had a value of 10⁴Ω/□ or more and thus exhibited insulating properties.

For each of the produced collectors (PP-1 to PP-10, PPc21 to PPc23, NP-1 to NP-8, and NPc21 to NPc23), the disposition and the area proportion (area rate) of the polymer anchored portion were checked as follows.

As a result of observing the surface (the surface planned to be subjected to lamination) of each of the positive electrode sheets PK-1 to PK-10 and the negative electrode sheets NK-1 to NK-8, which had been exposed by removing the active material layer, with an electron microscope (magnification: 2,000 times), in all cases, the polymer anchored portions and the electron conductive portions were respectively mixedly present randomly in an indeterminate shape in which they are finely scattered, over the entire surface of the current collector. On the other hand, the presence of the polymer anchored portion could not be confirmed in the positive electrode sheets PKc21 and PKc22 and the negative electrode sheets NKc21 and NKc22. This is conceived to be because even in a case where the polymer anchored portion is present on the surface of the collector, the polymer anchored portion is once dissolved by the composition for forming an active material layer during the formation of the active material layer and then incorporated into the active material layer. In the positive electrode sheet PKc23 and the negative electrode sheet NKc23, the polymer anchored portion was slightly present (remained) on the surface of the collector.

In addition, for each sheet, the area rate of the anchored portion was calculated according to Expression: [S_{P}/(S_{C}+S_{P})]×100 (%), where an exposed area of the collector is denoted as S_{C} and an area of the polymer anchored portion is denoted as S_{P} in the visual field in the observation with the electron microscope (magnification: 2,000 times).

Further, in the positive electrode sheets PK-1 to PK-10 and the negative electrode sheets NK-1 to NK-8, as a result of calculating or checking the surface area and the thickness of the polymer anchored portion and the distance between the polymer anchored portions according to the above-described method after confirming the polymer anchored portion, all of them were included in the above-described ranges.

### <Evaluation of Adhesiveness>

A test piece having a length of 20 mm and a width of 20 mm was cut out from each of the produced sheets (the positive electrode sheet and the negative electrode sheet). 11 cuts were made in the test piece using a utility knife so that the cuts reached the collector (the aluminum foil or the copper foil) at 1 mm intervals parallel to one side. In addition, 11 cuts were made so that the cuts reached the collector at 1 mm intervals in the direction perpendicular to the cuts. In this manner, 100 squares were formed on the test piece.

A cellophane tape (registered trademark) having a length of 15 mm and a width of 18 mm was attached to the surface of the electrode active material layer of each of the sheets (the positive electrode sheet and the negative electrode sheet) to cover all of the 100 squares. The surface of the Cellophane tape (registered trademark) was rubbed with an eraser and pressed against the electrode active material layer to be adhered thereto. Two minutes after the Cellophane tape (registered trademark) was attached, the end of the Cellophane tape (registered trademark) was held and pulled upward vertically with respect to the sheet, thereby being peeled off. After peeling off the Cellophane tape (registered trade name), the surface of the electrode active material layer was visually observed, and the number X of squares in which the peeling from the collector did not occur at all was counted. The adhesiveness of the electrode active material layer to the collector was evaluated by determining where it was included in any of the following evaluation standards.

In this test, It is indicated that the larger the number of counted squares in which the peeling from the collector has not occurred, the higher the adhesiveness between the solid particles, and the higher the adhesiveness between the active material layer and the collector. In a case where the evaluation standard is “D” or higher, the adhesive force between the collector and the active material layer is strong, and the occurrence of the peeling of the collector can be suppressed even in a case of manufacturing by a roll-to-roll method, which is the pass level of the present invention. The results are shown in Table 2.

### —Evaluation Standards—

A: X≥90

$$B : 90 > X \geq 80 \\ C : 80 > X \geq 70 \\ D : 70 > X \geq 60 \\ E : 60 > X \geq 50$$

F: 50>X

TABLE 2

| | | | Polymer anchored portion | | | | | | | | | | |
|---|---|---|---|---|---|---|---|---|---|---|---|---|---|
| | | | | | Content | | Active material layer | | | | | Area | |
| | | | | Solubility | of | | | Solid | Binder (D) | | | rate of | |
| | | | | (Water, | polymer | Coating | Active | elec- | | Content | | anchored | |
| Electrode sheet | | Col- | Polymer | 25° C.) | (A) | amount | material | trolyte | Solu- | of solid | Adhe- | portion | |
| | No. | lector | (A) | (g/110 g) | (%) | (g/m²) | (C) | (B) | tion | contents | siveness | (%) | Note |
| Positive | PK-1 | Al | PEG1000 | A | 100 | 1.1 | NCM | LPS | D-1 | 1.0 | C | 85 | Present invention |
| electrode | PK-2 | Al | PVA | A | 100 | 1.1 | NCM | LPS | D-1 | 1.0 | A | 86 | Present invention |
| sheet | PK-3 | Al | S-1 | A | 100 | 1.1 | NCM | LPS | D-1 | 1.0 | A | 65 | Present invention |
| | PK-4 | Al | S-2 | B | 100 | 1.1 | NCM | LPS | D-1 | 1.0 | A | 55 | Present invention |
| | PK-5 | AI | S-3 | A | 100 | 1.1 | NCM | LPS | D-1 | 1.0 | A | 82 | Present invention |
| | PK-6 | Al | S-4 | B | 100 | 1.1 | NCM | LPS | D-1 | 1.0 | B | 41 | Present invention |
| | PK-7 | Al | S-1 | A | 100 | 1.1 | NCM | LLT | D-1 | 1.0 | B | 67 | Present invention |
| | PK-8 | Al | S-1/T-1 | A | 50 | 1.1 | NCM | LPS | D-1 | 1.0 | C | 42 | Present invention |
| | PK-9 | Al | S-1 | A | 100 | 1.4 | NCM | LPS | D-1 | 1.0 | A | 82 | Present invention |
| | PK-10 | Al | S-1 | A | 100 | 0.5 | NCM | LPS | D-1 | 1.0 | C | 45 | Present invention |
| Negative | NK-1 | Cu | PEG1000 | A | 100 | 1.1 | Graphite | LPS | D-1 | 1.0 | C | 82 | Present invention |
| electrode | NK-2 | Cu | PVA | A | 100 | 1.1 | Graphite | LPS | D-1 | 1.0 | A | 82 | Present invention |
| sheet | NK-3 | Cu | S-1 | A | 100 | 1.1 | Graphite | LPS | D-1 | 1.0 | A | 60 | Present invention |
| | NK-4 | Cu | S-2 | B | 100 | 1.1 | Graphite | LPS | D-1 | 1.0 | A | 52 | Present invention |
| | NK-5 | Cu | S-3 | A | 100 | 1.1 | Graphite | LPS | D-1 | 1.0 | A | 81 | Present invention |
| | NK-6 | Cu | S-4 | B | 100 | 1.1 | Graphite | LPS | D-1 | 1.0 | B | 35 | Present invention |
| | NK-7 | Cu | S-1 | A | 100 | 1.1 | Graphite | LLT | D-1 | 1.0 | B | 58 | Present invention |
| | NK-8 | Cu | S-1/T-1 | A | 50 | 1.1 | Graphite | LPS | D-1 | 1.0 | C | 33 | Present invention |
| Positive | PKc21 | Al | T-1 | D | 100 | 1.1 | NCM | LPS | D-1 | 1.0 | E | — | Comparative |
| electrode | | | | | | | | | | | | | Example |
| sheet | PKc22 | Al | SBR | D | 100 | 1.1 | NCM | LPS | D-1 | 1.0 | F | — | Comparative |
| | | | | | | | | | | | | | Example |
| | PKc23 | Al | S-1/T-1 | A | 45 | 1.1 | NCM | LPS | D-1 | 1.0 | E | 6 | Comparative |
| | | | | | | | | | | | | | Example |
| Negative | NKc21 | Cu | T-1 | D | 100 | 1.1 | Graphite | LPS | D-1 | 1.0 | E | — | Comparative |
| electrode | | | | | | | | | | | | | Example |
| sheet | NKc22 | Cu | SBR | D | 100 | 1.1 | Graphite | LPS | D-1 | 1.0 | F | — | Comparative |
| | | | | | | | | | | | | | Example |
| | NKc23 | Cu | S-1/T-1 | A | 45 | 1.1 | Graphite | LPS | D-1 | 1.0 | E | 4 | Comparative |
| | | | | | | | | | | | | | Example |

### Abbreviations in Table

PEG 1000: polyethylene glycol 1000 (manufactured by FUJIFILM Wako Pure Chemical Corporation)
PVA: polyvinyl alcohol, average degree of polymerization: 1,500 to 1,800, manufactured by FUJIFILM Wako Pure Chemical Corporation
SBR: styrene-butadiene rubber, model number: SL552, manufactured by JSR Corporation
NCM: LiNi_{1/3}Co_{1/3}Mn_{1/3}O₂, manufactured by Sigma-Aldrich Co., LLC
LPS: LPS synthesized in Synthesis Example A
LLT: Li_{0.33}La_{0.55}TiO₃, average particle diameter: 3.25 μm, manufactured by TOSHIMA Manufacturing Co., Ltd.
   <Manufacturing of all-Solid State Secondary Battery>

First, each of a positive electrode sheet including a solid electrolyte layer, and a negative electrode sheet including a solid electrolyte layer, which would be used for manufacturing an all-solid state secondary battery, was produced.

—Production of Positive Electrode Sheets PK-1 to PK-10 and PKc21 to PKc23, which Include Solid Electrolyte Layer—

A solid electrolyte sheet S101 for an all-solid state secondary battery, produced by the following method, was overlaid on the positive electrode active material layer of each of the positive electrode sheets shown in the column of “Electrode active material layer (sheet No.)” of Table 3 so that the solid electrolyte layer came into contact with the positive electrode active material layer, transferred (laminated) by being pressurized at 50 MPa in an environment of 25° C. using a press machine, and then pressurized at 600 MPa in an environment of 25° C., whereby each of positive electrode sheets PK-1 to PK-10, and PKc21 to PKc23, which includes a solid electrolyte layer having a thickness of 30 μm (thickness of positive electrode active material layer: 80 μm), was produced.

—Production of Negative Electrode Sheets NK-1 to NK-8 and NKc21 to NKc23, Each Provided with Solid Electrolyte Layer—

A solid electrolyte sheet S101 for an all-solid state secondary battery, produced by the following method, was overlaid on the negative electrode active material layer of each of the negative electrode sheets shown in the column of “Electrode active material layer (sheet No.)” of Table 4 so that the solid electrolyte layer came into contact with the negative electrode active material layer, transferred (laminated) by being pressurized at 50 MPa in an environment of 25° C. using a press machine, and then pressurized at 600 MPa in an environment of 25° C., whereby each of negative electrode sheets NK-1 to NK-8, and NKc21 to NKc23, which includes a solid electrolyte layer having a thickness of 30 μm (thickness of negative electrode active material layer: 70 μm), was produced.

A solid electrolyte sheet S101 for an all-solid state secondary battery used for producing an electrode sheet for an all-solid state secondary battery was prepared as follows.

### —Preparation of Inorganic Solid Electrolyte-Containing Composition S101—

60 g of zirconia beads having a diameter of 5 mm were put into a 45 mL container made of zirconia (manufactured by FRITSCH), and 8.4 g of the LPS synthesized in the above Synthesis Example A, 0.6 g (in terms of solid content mass) of KYNAR FLEX 2500-20 (product name, PVDF-HFP: polyvinylidene fluoride-hexafluoropropylene copolymer, manufactured by Arkema S.A.), and 11 g of butyl butyrate as the dispersion medium were put into the above container. Then, this container was set in a planetary ball mill P-7 (product name, manufactured by FRITSCH). Mixing was carried out at a temperature of 25° C. and a rotation speed of 150 rpm for 10 minutes to prepare an inorganic solid electrolyte-containing composition (slurry) S101.

—Production of Solid Electrolyte Sheet S101 for all-Solid State Secondary Battery—

Using a Baker type applicator (product name: SA-201, manufactured by Tester Sangyo Co., Ltd.), the inorganic solid electrolyte-containing composition S101 obtained as described above was applied on an aluminum foil having a thickness of 20 μm, and heating was carried out at 80° C. for 2 hours to dry (remove the dispersion medium) the inorganic solid electrolyte-containing composition. Then, using a heat press machine, the inorganic solid electrolyte-containing composition dried at a temperature of 120° C. and a pressure of 40 MPa for 10 seconds was heated and pressurized to produce a solid electrolyte sheet S101 for an all-solid state secondary battery. The film thickness of the solid electrolyte layer was 50 μm.

—Manufacturing of all-Solid State Secondary Battery—

Next, an all-solid state secondary battery No. 101 having a layer configuration illustrated in FIG. 2 was manufactured.

The positive electrode sheet PK-1 (the aluminum foil of the solid electrolyte-containing sheet S101 had been peeled off), which included the solid electrolyte layer obtained as described above, was cut out into a disk shape having a diameter of 14.5 mm and placed in a stainless 2032-type coin case into which a spacer and a washer had been incorporated. Next, a lithium foil cut out in a disk shape having a diameter of 15 mm was overlaid on the solid electrolyte layer. After further overlaying a stainless steel foil thereon, the 2032-type coin case was crimped to manufacture an all-solid state secondary battery No. 101.

The all-solid state secondary battery No. 101 μmanufactured in this manner has a layer configuration illustrated in FIG. 1 (however, the lithium foil corresponds to a negative electrode active material layer 2 and a negative electrode collector 1).

Each of all-solid state secondary batteries Nos. 102 to 110 and c101 to c103 was manufactured in the same manner as in the manufacturing of the all-solid state secondary battery No. 101, except that in the manufacturing of the all-solid state secondary battery No. 101, a positive electrode sheet which has a solid electrolyte layer and is indicated by No. shown in the column of “Electrode active material layer (sheet No.)” of Table 4 was used instead of the positive electrode sheet PK-1 including a solid electrolyte layer.

In addition, an all-solid state secondary battery No. 111 having a layer configuration illustrated in FIG. 1 was manufactured as follows.

The negative electrode sheet NK-1 (the aluminum foil of the solid electrolyte-containing sheet S101 had been peeled off), which included the solid electrolyte layer obtained as described above, was cut out into a disk shape having a diameter of 14.5 mm and placed in a stainless 2032-type coin case into which a spacer and a washer had been incorporated. Next, a positive electrode sheet (a positive electrode active material layer) punched out from the positive electrode sheet for an all-solid state secondary battery produced below into a disk shape having a diameter of 14.0 mm was overlaid on the solid electrolyte layer. A stainless steel foil (a positive electrode collector) was further layered thereon to form a laminate for an all-solid state secondary battery (a laminate consisting of stainless steel foil—aluminum foil—positive electrode active material layer—solid electrolyte layer—negative electrode active material layer—copper foil). Then, the 2032-type coin case was crimped to manufacture an all-solid state secondary battery No. 111.

A positive electrode sheet for an all-solid state secondary battery to be used in the manufacturing of the all-solid state secondary battery No. 111 was prepared.

### —Preparation of Positive Electrode Composition—

180 beads of zirconia beads having a diameter of 5 mm were put into a 45 mL container made of zirconia (manufactured by FRITSCH), 2.7 g of the LPS2 synthesized in the above Synthesis Example A, and 0.3 g of KYNAR FLEX 2500-20 (product name, PVDF-HFP: polyvinylidene fluoride—hexafluoropropylene copolymer, manufactured by Arkema S.A.) in terms of solid content mass and 22 g of butyl butyrate were put into the above container. The container was set in a planetary ball mill P-7 (product name), and stirring was carried out at 25° C. and a rotation speed of 300 rpm for 60 minutes. Then, 7.0 g of LiNi_{1/3}Co_{1/3}Mn_{1/3}O₂ (NMC) and 0.15 g of acetylene black were put into the container as the positive electrode active material, and similarly, the container was set in a planetary ball mill P-7, mixing was continued at 25° C. and a rotation speed of 100 rpm for 5 minutes to prepare a positive electrode composition.

—Production of Positive Electrode Sheet for all-Solid State Secondary Battery—

The positive electrode composition obtained as described above was applied onto an aluminum foil (a positive electrode collector) having a thickness of 20 μm with a Baker type applicator (product name: SA-201), heating was carried out at 100° C. for 2 hours to dry (to remove the dispersion medium) the positive electrode composition. Then, using a heat press machine, the dried positive electrode composition was pressurized (10 MPa, 1 μminute) at 25° C. to produce each of positive electrode sheets for an all-solid state secondary battery, having a positive electrode active material layer having a film thickness of 80 km.

Each of all-solid state secondary batteries Nos. 112 to 118 and c104 to c106 was manufactured in the same manner as in the manufacturing of the all-solid state secondary battery No. 111, except that in the manufacturing of the all-solid state secondary battery No. 111, a negative electrode sheet which has a solid electrolyte layer and is indicated by No. shown in the column of “Electrode active material layer (sheet No.)” of Table 4 was used instead of the negative electrode sheet NK-1 including a solid electrolyte layer.

The following characteristics or physical properties of the produced all-solid state secondary battery were measured or evaluated, and the results are shown in Table 3.

### <Measurement of Ion Conductivity>

The ion conductivity of each of the manufactured all-solid state secondary batteries was measured. Specifically, the alternating-current impedance of each of the all-solid state secondary batteries was measured in a constant-temperature tank (25° C.) using a 1255B FREQUENCY RESPONSE ANALYZER (product name, manufactured by SOLARTRON Analytical) at a voltage magnitude of 5 mV and a frequency of 1 MHz to 1 Hz. From the measurement result, the resistance of the sample for measuring ion conductivity in the layer thickness direction was determined, and the ion conductivity was determined by the calculation according to Expression (1).

$$Ion conductivity σ ( mS / cm ) = 1 , 000 \times sample layer \\ thickness ( cm ) / [ resistance ( Ω ) \times sample area ( {cm}^{2} ) ] \qquad Expression ( 1 )$$

In Expression (1), the thickness of the sample layer is a total layer thickness of the solid electrolyte layer and the electrode active material layer, which is obtained by subtracting the thickness of the collector. The sample area is the area of the disk-shaped sheet having a diameter of 14.5 mm.

It was determined where the obtained ion conductivity a was included in any of the following evaluation standards.

In this test, in a case where the evaluation standard is “E” or higher, the ion conductivity a is the pass level.

### —Evaluation Standards—

A: 0.30<σ

$$B : 0.25 \leq σ < 0.3 \\ C : 0.2 \leq σ < 0.25 \\ D : 0.15 \leq σ < 0.2 \\ E : 0.1 \leq σ < 0.15$$

F: σ<0.10

### <Evaluation of Cycle Characteristics>

The discharge capacity retention rate of each of the manufactured all-solid state secondary batteries was measured using a charging and discharging evaluation device TOSCAT-3000 (product name, manufactured by Toyo System Corporation).

Specifically, each of the all-solid state secondary batteries was charged in an environment of 30° C. at a current density of 0.1 mA/cm² until the battery voltage reached 3.6 V. Then, the battery was discharged at a current density of 0.1 mA/cm² until the battery voltage reached 2.5 V. One charging operation and one discharging operation were set as one cycle of charging and discharging, and 3 cycles of charging and discharging were repeated under the same conditions to carry out initialization.

Then, the high-speed charging at a current density of 1.0 mA/cm² until the battery voltage reaches 3.6 V and the high-speed charging and discharging at a current density of 1.0 mA/cm² until the battery voltage reaches 2.5 V was set as one cycle, and this high-speed charging and discharging cycle was repeatedly carried out 800 cycles. The discharge capacity of each all-solid state secondary battery at the first cycle of the high-speed charging and discharging and the discharge capacity at the 800th cycle of the high-speed charging and discharging were measured with a charging and discharging evaluation device: TOSCAT-3000 (product name).

The discharge capacity retention rate was determined according to the following expression, and this discharge capacity retention rate was applied to the following evaluation standards to evaluate the cycle characteristics of the all-solid state secondary battery. In this test, an evaluation standard of “D” or higher is the pass level.

$$Discharge capacity retention rate ( \% ) = ( discharge capacity at 800 th cycle / discharge capcity at first cycle ) \times 100$$

In this test, the higher the evaluation standard is, the better the battery performance (the cycle characteristics) is, and the initial battery performance can be maintained even in a case where a plurality of times of high-speed charging and discharging are repeated (even in a case of the long-term use).

All of the all-solid state secondary batteries for evaluation according to the embodiment of the present invention exhibited the discharge capacity values at the first cycle which are sufficient for functioning as an all-solid state secondary battery. Moreover, the all-solid state secondary battery for evaluation according to the embodiment of the present invention maintained excellent cycle characteristics even in a case where the typical charging and discharging cycle was repeatedly carried out under the same conditions as those in the above-described initialization instead of those in the high-speed charging and discharging.

### —Evaluation Standards—

A: 90%≤discharge capacity retention rate

$$B : 85 \% \leq discharge capacity retention rate < 90 \%$$

$$C : 80 \% \leq discharge capacity retention rate < 85 \%$$

$$D : 75 \% \leq discharge capacity retention rate < 80 \%$$

$$E : 70 \% \leq discharge capacity retention rate < 75 \%$$

$$F : 60 \% \leq discharge capacity retention rate < 70 \%$$

G: Discharge capacity retention rate<60%

TABLE 3

| | Layer configuration | | | | |
|---|---|---|---|---|---|
| | Electrode active | Solid | | | |
| | material layer | electrolyte layer | Ion | Cycle | |
| No. | (sheet No.) | (sheet No.) | conductivity | characteristics | Note |
| 101 | PK-1 | S101 | B | C | Present invention |
| 102 | PK-2 | S101 | B | B | Present invention |
| 103 | PK-3 | S101 | A | A | Present invention |
| 104 | PK_4 | S101 | A | A | Present invention |
| 105 | PK-5 | S101 | B | A | Present invention |
| 106 | PK-6 | S101 | A | B | Present invention |
| 107 | PK-7 | S101 | A | B | Present invention |
| 108 | PK-8 | S101 | B | B | Present invention |
| 109 | PK-9 | S101 | C | B | Present invention |
| 110 | PK-10 | S101 | A | A | Present invention |
| 111 | NK-1 | S101 | B | C | Present invention |
| 112 | NK-2 | S101 | B | B | Present invention |
| 113 | NK-3 | S101 | A | A | Present invention |
| 114 | NK-4 | S101 | A | A | Present invention |
| 115 | NK-5 | S101 | B | A | Present invention |
| 116 | NK-6 | S101 | A | B | Present invention |
| 117 | NK-7 | S101 | A | B | Present invention |
| 118 | NK-8 | S101 | B | B | Present invention |
| c101 | PKc21 | S101 | F | E | Comparative Example |
| c102 | PKc22 | S101 | F | F | Comparative Example |
| c103 | PKc23 | S101 | E | E | Comparative Example |
| c104 | NKc21 | S101 | F | E | Comparative Example |
| c105 | NKc22 | S101 | F | F | Comparative Example |
| c106 | NKc23 | S101 | E | E | Comparative Example |

The following facts can be seen from the results shown in Table 1. That is, all of the electrode sheets PKc21, PKc22, NKc21, and NKc22 of Comparative Examples, in which the polymer anchored portion containing a polymer not satisfying the solubility in water (water, 25° C.) defined in the present invention is formed on the surface of the collector, and then the electrode active material layer is formed, are inferior in the adhesiveness between the current collector and the active material layer. In addition, the electrode sheets PKc23 and NKc23 of Comparative Example, in which the polymer anchored portion having a content of the polymer (A) of 45% by mass is formed on the surface of the collector, and then the electrode active material layer is formed, are inferior in the adhesiveness between the current collector and the active material layer. In addition, all of the all-solid state secondary batteries Nos. c101 to c106 which are formed of these electrode sheets cannot achieve sufficient ion conductivity and cycle characteristics.

On the other hand, all of the electrode sheets according to the embodiment of the present invention, in which the polymer anchored portion containing 50% by mass or more of the polymer satisfying the solubility (water, 25° C.) specified in the present invention is provided at a part of the interface between the collector and the electrode active material layer, exhibit strong adhesiveness between the collector and the active material layer. As a result, all of the all-solid state secondary batteries Nos. 101 to 118 formed of these electrode sheets exhibit excellent cycle characteristics while maintaining high ion conductivity.

It is noted that it is revealed that an electrode sheet, which has a collector including a thin film-shaped polymer anchored portion of PEG 1000 on the entire surface of the collector by increasing the concentration of solid contents of the polymer composition and has an electrode active material layer, does not exhibit electron conductivity and does not function as an electrode of an all-solid state secondary battery.

The present invention has been described together with the embodiments of the present invention. However, the inventors of the present invention do not intend to limit the present invention in any part of the details of the description unless otherwise specified, and it is considered that the present invention should be broadly construed without departing from the spirit and scope of the invention shown in the attached “WHAT IS CLAIMED IS”.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery
21: electrode sheet
22: collector
22a: exposed collector surface (electron conductive portion)
23: polymer anchored portion
24: electrode active material layer

What is claimed is:

1. An electrode sheet for an all-solid state secondary battery, comprising:
an electrode active material layer on at least one surface of a collector,
wherein the electrode active material layer has an inorganic solid electrolyte (B) having an ion conductivity of a metal belonging to Group 1 or Group 2 in the periodic table, and an active material (C), and
the electrode sheet for an all-solid state secondary battery has an insulating polymer anchored portion that contains 50% by mass or more of a polymer (A) having a solubility of 1 g/100 g or more in water at 25° C., at a part of an interface between the collector and the electrode active material layer.

2. The electrode sheet for an all-solid state secondary battery according to claim 1,
wherein the polymer anchored portion does not contain conductive particles.

3. The electrode sheet for an all-solid state secondary battery according to claim 1,
wherein the polymer (A) has the following acidic functional group or a salt thereof,
<acidic functional group>
a carboxy group, a phosphate group, a phosphonate group, a phosphinate group, and a sulfonate group.

4. The electrode sheet for an all-solid state secondary battery according to claim 1,
wherein the polymer (A) has a salt of a basic functional group.

5. The electrode sheet for an all-solid state secondary battery according to claim 1,
wherein the inorganic solid electrolyte is a sulfide-based inorganic solid electrolyte.

6. The electrode sheet for an all-solid state secondary battery according to claim 1,
wherein the polymer (A) includes at least one of a (meth)acrylic polymer or a vinyl polymer.

7. The electrode sheet for an all-solid state secondary battery according to claim 1,
wherein the electrode active material layer contains a binder (D).

8. The electrode sheet for an all-solid state secondary battery according to claim 7,
wherein the binder (D) includes at least one of a (meth)acrylic polymer or a vinyl polymer.

9. An all-solid state secondary battery comprising:
a positive electrode;
a negative electrode; and
a solid electrolyte layer between the positive electrode and the negative electrode,
wherein at least one of the positive electrode or the negative electrode is composed of the electrode sheet for an all-solid state secondary battery according to claim 1.
